(19) United States
(12) Patent Application Publication
(10) Pub. No.: US 2015/0039331 A1
(43) Pub. Date: Feb. 5, 2015

(54) ASSESSING PHARMACEUTICALS

(71) Applicant: Real Endpoints LLC, Westport, CT (US)

(72) Inventors: Roger Longman, Westport, CT (US); Julie Eskay-Eagle, Armonk, NY (US); Keith Bradbury, Blauvelt, NY (US); Amy Steinkellner, Indian Rocks Beach, FL (US); Jane Barlow, Scottsdale, AZ (US); Ronald Aubert, Ringwood, NJ (US); Winston Wong, Longboat Key, FL (US); John Whang, Mountain Lakes, NJ (US)

(73) Assignee: Real Endpoints LLC, Westport, CT (US)

(21) Appl. No.: 14/448,195

(22) Filed: Jul. 31, 2014

Related U.S. Application Data
(63) Continuation-in-part of application No. 13/958,030, filed on Aug. 2, 2013.

(51) Int. Cl. G06F 19/00

(52) U.S. Cl. CPC G06F 19/326
USPC 705/2

(57) ABSTRACT

Among other things, data is stored for each of several pharmaceuticals that are associated with a given indication. The data is representative of elements of value of the pharmaceutical including elements within the domains of clinical efficacy, safety and use, and economics. A computer is used to calculate a drug score for each of the pharmaceuticals based on the data that is representative of the elements of value. Through a user interface, the relative scores and the basis on which they were calculated are displayed to enable decisions about the pharmaceuticals.

### CLAIM OF PRIORITY

This application is a continuation-in-part of and claims priority to U.S. patent application Ser. No. 13/958,030, filed on Aug. 2, 2013, the entire contents of which are incorporated here by reference.

### BACKGROUND

This description relates to assessing pharmaceuticals.

Drug costs are skyrocketing, at rates much greater than the value of the improved benefits they provide. The costliest drugs—those most responsible for the growth in total pharmaceutical spending—are so-called “specialty drugs,” drugs for relatively small patient populations of people suffering from severe diseases such as multiple sclerosis, rheumatoid arthritis, prostate cancer, and hepatitis C. Few specialty drugs (we sometimes use the words drugs and pharmaceuticals interchangeably) face competition from generic drugs (that is, for example, drugs that contain the same active ingredient as, and are approved by the FDA as therapeutically equivalent to, a branded drug, but which lack patent protection and therefore are much cheaper than patent-protected products). Generic competition is the surest way of keeping down drug costs.

In part because of federal and state requirements, in part to make sure physicians are prescribing medically and economically appropriate drugs, virtually all insurance companies and hospitals have established formularies, lists of drugs that both physicians are permitted to prescribe and insurance companies will reimburse (partly or fully pay for). In more or less restrictive ways, these formularies generally “position” drugs and form the basis for coverage rules: for example, a relatively restrictive formulary may indicate one or two drugs in a category (for example, in multiple sclerosis, Copaxone and a high-dose beta interferon product) as the preferred drugs, which means that the patient will pay the lowest share of the drug cost (co-pay) by buying the preferred drugs. Other competitive drugs will be non-preferred, which means that the patient will pay a higher percentage of the drug's cost. In this way, insurers and hospitals can influence physicians to prescribe preferred drugs—which is how a health plan or hospital can use its leverage to negotiate a lower price from the manufacturer. The fewer drugs a plan allows patients to access, the greater their ability to extract discounts, as the discounts are related to how many patients will use a drug.

Formularies, and their associated coverage rules, also have other ways to encourage the use of preferred drugs: they can, for example, specify that particular drugs can't be prescribed, or won't be reimbursed, unless a preferred drug is prescribed first, a so-called “step edit”. Sometimes, the formulary will require a physician to get permission to prescribe the drug—a “prior authorization”. Even if permission might be granted, the physician often doesn't want to take the time to go through the bureaucratic process prior authorization requires.

While many formularies are quite restrictive when it comes to primary care drugs (drugs for treating broadly prevalent conditions, such as hypertension and high cholesterol), few formularies are restrictive when it comes to specialty drugs. The reason is historical as well as practical: when formulary practice was being established, there were fewer specialty drugs than today, those drugs were not particularly expensive, and they served small populations. There was, in short, little need to manage their use. Moreover, because these diseases can be quite serious, patients and doctors can cause a considerable ruckus, with significant adverse PR consequences, if they feel they are unjustifiably denied the medicines of their choice. In addition, a large number of specialty drugs circumvent the usual prescription drug payment process because they are administered in a physician's office or other health care delivery setting (e.g., infusion center) and are therefore reimbursed outside of the prescription drug claims process.

In part because specialty drugs frequently fall outside of health plan formularies and the prescription drug claims process, their total cost has risen dramatically. Pharmaceutical companies, recognizing their economic potential, have refocused much of their research and development from creating primary care drugs to specialty drugs. The pharmaceutical industry has introduced over 20 new specialty drugs in the past 3 years and their prices have risen enormously. For example, in 2012, twelve new cancer drugs were introduced, each at an annualized price of more than $100,000 and none offering, on average, more than a few extra months of life. The average annual price of a rheumatoid arthritis drug introduced in the last decade is about $60,000; none of these drugs is significantly more effective than the others. The cost of specialty drugs is now roughly 30-35% of the total drug bill in the United States.

A formulary typically is created and modified by a Pharmacy & Therapeutics (P&T) committee, a group of medical and pharmacy staff and consultants appointed or engaged by an insurance company, a health plan, hospital, IDN (integrated delivery network), or ACO (accountable care organization) (we sometimes referred to these organizations and others that have an interest in formularies and the costs of medicines as “stakeholders”). These P&T committees meet regularly—most meet about four times per year—to assess the value of drugs which have newly reached the market following regulatory approval, or how new medical, scientific and economic information affects the value of existing drugs. Based upon these committee meetings the committee determines changes to the formulary. For example, if a new multiple sclerosis (MS) drug has been approved, the P&T committee assesses its value and then decides whether to add it to the formulary, in what position, and with what restrictions. (If it's a specialty drug, as in this MS drug example, the P&T generally adds it to the formulary without significantly distinguishing its position from its competitors.) For example, at Harvard Pilgrim Health Plan, the formulary lists three older drugs—Copaxone, Rebif and Avonex—as simply preferred (Tier 2) but otherwise undistinguished; all newer drugs, those introduced in the last three years (Gilenya, Aubagio and Tecfidera), are simply non-preferred—and likewise undistinguished from each other.

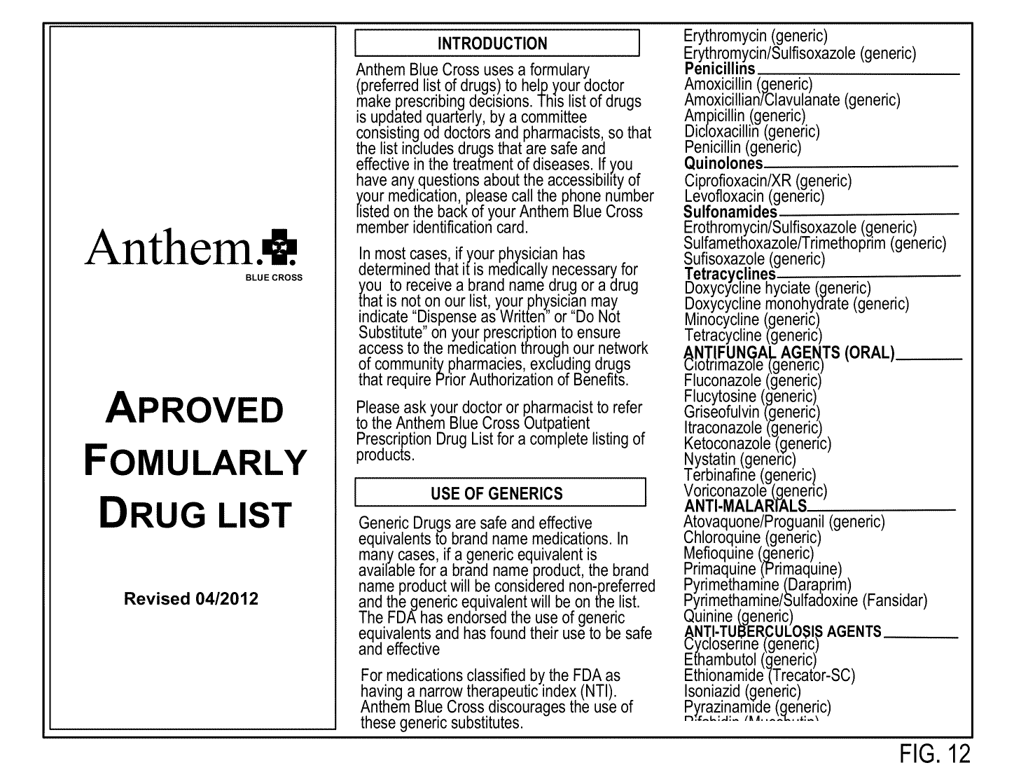

FIG. 12 shows an example of a portion of a formulary of an insurance company.

To help the P&T committee make these assessments, the pharmacy departments of insurance companies and hospitals gather assessment data including data from clinical trials, FDA approval documents, and information provided by the manufacturers. Some kinds of assessment data are assembled and sold by data vendors. Most payers and hospitals subscribe, for example, to information services, such as Micromedex and Facts & Comparisons, which consolidate in a single database all the label information from approved drugs and sometimes articles, or electronic links or references to articles, from medical journals with data from clinical trials. The Academy of Managed Care Pharmacy provides an electronic platform through which manufacturers can submit data to P&T committees. But none of these databases synthesizes the information or provides any recommendations on what to do with it. That's the job of the pharmacists working for the payer (these pharmacists usually have many other duties as well) and the members of the P&T committees. Other plans have essentially outsourced much of the heavy-lifting of the assessment process to pharmacy benefit managers (PBMs), companies who make money largely on drug-distribution margins and manufacturer rebates. Plans may not fully trust the drug choices of PBMs whose economics are often tied to the deals they sign with specific manufacturers for preferring their drugs.

Finally, very few of these P&T assessments—at hospitals, plans or PBMs—are particularly systematic—and almost none of them transparent to the hospital, the insurer, the pharmacies, the manufacturers, the physicians, the patients, or any of the other stakeholders. The assessment processes differ from P&T committee to P&T committee, in the information they use and the importance they ascribe to the different assessment characteristics (for example, clinical efficacy on symptoms vs. disease modification vs. side effects vs. drug economics). In general, the process is not documented—so it is difficult for any stakeholder—physicians, for example, or the employer-clients of the insurance companies or PBMs—to analyze, let alone challenge formulary decisions. The less transparency, the less trust in the process. This has practical problems. Physicians are less likely to follow formulary recommendations because they have little faith in their validity. And insurance-company clients, such as employers, have little reason to believe that the formulary choices that plans make necessarily reflect the best interests of the clients' employees.

Some other shortcomings of the existing assessment system are that P&T committees do not assess all drugs because they don't have the time, and several of the most expensive drugs are not managed through the pharmacy claims process, but instead through the medical benefit claims process, which often bypasses the established P&T review and reimbursement process. Most P&T committees make decisions on 3-4 new drugs each meeting. Since most P&T committees meet quarterly, they make even superficially reasoned decisions on only 12-16 drugs per year. This is inadequate: in 2012, the FDA approved 39 drugs. And there was plenty of new information released about existing drugs which—were a P&T committee to have the time to examine it—could clearly change formulary decisions.

Most P&T committees do not assess drugs which physicians and other medical providers inject into, infuse into, or otherwise provide to patients at their medical facilities (as opposed to drugs which patients pick up at pharmacies and take themselves). These provider-delivered drugs, called medical-benefit drugs, are paid for differently (typically the provider buys the drug, bills the insurance company for the cost of the drug plus a dispensing fee, which is calculated as a percentage of the cost of the drug). In these situations the dispensing provider has an incentive to prescribe medical-benefit drugs, and in particular expensive medical-benefit drugs (the higher the cost of the drug, the higher the dispensing fee). Theoretically, these medical-benefit drugs have their own sets of coverage rules, created by a plan's medical policy team, but in practice such rules are not particularly restrictive, when they exist at all—in part because they are administered by the health plan personnel who are responsible for the medical benefit in its entirety, which includes policies concerning the coverage of claims for medical treatments, surgical procedures, and hospitalizations. Indeed, the medical policy team often is so busy that the rules around medical-benefit drugs are often written for plans and hospitals by specialty distributors who make more money the more the drugs are used—hence they have no incentive to impose restrictive rules.

In short, payers and hospitals spend significant time and effort assessing too few drugs and doing so unsystematically and opaquely. Their current solutions are inadequate. Another problem for health plans is that they often do not adequately understand the importance, (e.g., clinical importance, economic importance, or both), of drugs that have not yet been approved—but are likely to be approved within a year or two. Such drugs can often have a huge impact on beneficiaries and on the plan's budget—an impact for which most health plans are unprepared. For example, in October 2014, a new Hepatitis C drug will be approved making an oral (not intravenously infused) drug available to treat this disease for the first time. As a result, it is believed that many more patients will present for treatment, potentially bankrupting health plans because the oral drug can cost $60,000-100,000 per treatment. Several other new regimens for treating Hepatitis C are anticipated to undergo FDA review in the coming year, making P&T review an inadequate process for vetting these therapies. In the past, health plans have not needed to consider the clinical and economic impact of drugs prior to FDA approval or market availability. In this case, each regimen demonstrates clinical value in different subtypes and subpopulations and is very expensive. The RxScorecard is particularly useful in this context as it is updated frequently and synthesizes the attributes of drug regimens by subtype and subpopulation, which is otherwise very time consuming for health plan and insurer pharmacy departments, as this is a challenge they have not been organized to address.

### SUMMARY

What we describe here is, among other things and in various implementations, a quantitative, consistent, and transparent system that aids the assessment of drugs, for example the assessment (and updating the assessment) of the value of older drugs, newly approved drugs, and drugs in the various stages of clinical development in the context of all of their competitors. It dramatically speeds up the assessment process, it frees pharmacists to spend time on more complicated tasks; it supports high-quality, clearly justifiable formulary decisions; enables cost-saving formulary choices; improves formulary compliance by providers; and facilitates communication among all stakeholders—physicians, patients, employers, and within the plan, medical policy and pharmacy groups. Manufacturers of pharmaceuticals can use this information to anticipate decisions by payers about the clinical utility and relative cost-benefit of their products relative to competing therapies, rather than retrospectively tracking the number of prescriptions for each drug. By definition, this includes only marketed drugs.

In general, in an aspect, data is stored for each of several pharmaceuticals or groups of pharmaceuticals that are associated with a given indication. The data is representative of elements of value of the pharmaceutical or group of pharmaceuticals including elements within the domains of clinical efficacy, safety and use, and economics. A computer is used to calculate a drug score for each of the pharmaceuticals and groups of pharmaceuticals based on the data that is representative of the elements of value. Through a user interface, the relative scores and the basis on which they were calculated are displayed to enable decisions about the pharmaceuticals or groups of pharmaceuticals, such as the reimbursement of pharmaceuticals or the identification of appropriate pharmaceuticals to treat a patient. The group of pharmaceuticals can include a multi-drug treatment regimen.

Implementations may include one or any combination of two or more of the following features. The drug score includes an aggregate of element scores for elements associated with each of the domains. The drug scores are for pharmaceuticals that are associated with a given medical indication. The user interface displays at least one of the data, a summary table, a coverage recommendation, an analysis, an element score associated with one of the domains, and a drug score. The calculating of the score may include multiplying an individual element's score by a weighting factor. A multiplier factor is associated with at least one of the following criteria: (a) a strength of evidence, (b) an extent of post-marketing experience, real world evidence, or both, (c) one or more labeled indications, and (d) non-drug costs. The user includes at least one of a health care provider, a health care payer, and a pharmaceutical company, a patient or an investor. A user can, through the user interface, specify an arbitrary weighting factor to be applied to any one or more of the element values when the drug score is calculated. The method includes pre-storing prose descriptions of a series of levels of value of at least one of the rating elements and a numerical rating associated with each of the levels, and through the interface, enabling a user to select one of the levels and the numerical rating applied in calculating the drug score, as well as the relative weight of that element within the drug score. Each of the element ratings and the weight of each element as a component of the drug score can be adjusted by the user to reflect his interpretations of the raw information used to arrive at ratings.

The method can include storing and displaying, through the user interface, prose descriptions of states of a medical condition and, for each of the prose descriptions, a prose explanation of an impact of a pharmaceutical on the state of the medical condition. The method can include displaying, through the user interface, a prose explanation of the basis for each of the domains, of the drug score that is calculated, and factors for consideration in placing the pharmaceutical in a formulary. Through the user interface, an explanation of the basis for a rating and adjustment of a rating for a rating element can be displayed, the explanation summarizing scholarly references. A graph of the respective scores of each of two or more pharmaceuticals associated with a medical indication, in each of two or more domains of value, can be displayed. A user can place the pharmaceutical on a formulary, or adjust its position on a formulary, based on the score or purchase a formulary reflective of the drug scores. The decisions can include decisions based on a cost of the pharmaceuticals or groups of pharmaceuticals. The method can include displaying, through the user interface, cost information associated with one or more of the pharmaceuticals or groups of pharmaceuticals. The method can include calculating cost information associated with one or more of the pharmaceuticals or groups of pharmaceuticals for each of multiple formulary choices, each of multiple coverage policy options, or both. The method can include displaying at least some of the calculated cost information.

In general, in an aspect, a user, through a computer interface, reviews, for each of several pharmaceuticals that are associated with a given indication, data that are representative of elements of value of the pharmaceutical including elements within the domains of clinical efficacy, safety and use, and economics, and a computer calculated drug score for each of the pharmaceuticals. The data is representative of the elements of value. A user can place the pharmaceuticals in positions on a formulary, and create coverage rules, reimbursement rules, or policies for pharmaceuticals based on the formulary.

In general, in an aspect, a method includes, for each of multiple pharmaceuticals or groups of pharmaceuticals that are associated with a given indication, storing data for multiple patient sub-groups, the data for each patient sub-group representative of elements of value of the pharmaceutical or group of pharmaceuticals for the patient sub-group, the elements of value including elements within the domains of clinical efficacy, safety and use, and economics. The method includes calculating a drug score for each of the pharmaceuticals and groups of pharmaceuticals for each of the patient sub-groups based on the data for the patient sub-group representative of the elements of value. The method includes, through a user interface, enabling a user to access a scorecard for each of the patient sub-groups, the scorecard for a patient sub-group displaying the drug scores for each of the pharmaceuticals and groups of pharmaceuticals for the patient sub-group.

Implementations may include one or any combination of two or more of the following features. The patient sub-groups include sub-populations of patients grouped by one or more patient characteristics, genotypes of patients grouped by one or more characteristics of the given indication, or both. The method includes enabling the user to modify one or more factors used by the computer in calculating the drug score. The method includes enabling the user to specify a weighting factor to be applied to one or more of the elements of value when the drug score is calculated. The scorecard includes a graphical display of the drug scores, a tabular display of the drug scores, or both. The scorecard is interactive. The method includes enabling identification of a target pharmaceutical or group of pharmaceuticals for each of the patient sub-groups based at least in part on the drug scores for each of the pharmaceuticals and groups of pharmaceuticals. The method includes enabling identification of the target pharmaceutical or group of pharmaceuticals based at least in part on a cost associated with each of the pharmaceuticals and groups of pharmaceuticals.

In general, in an aspect, a method includes, through a computer interface, enabling a user to review, for each of several pharmaceuticals or groups of pharmaceuticals that are associated with a given indication, data that is representative of elements of value of the pharmaceutical or group of pharmaceuticals including elements within the domains of clinical efficacy, safety and use, and economics, and a computer calculated drug score for each of the pharmaceuticals and groups of pharmaceuticals that is based on the data that is representative of the elements of value. The method includes enabling a user to place the pharmaceuticals or groups of pharmaceuticals in positions on a formulary, and creating coverage rules, policies, or both, for the pharmaceuticals or groups of pharmaceuticals based on the formulary.

In general, in an aspect, a method includes supporting assessments of the values of respective pharmaceuticals or groups of pharmaceuticals with respect to particular criteria for inclusion in one or more formularies. The supporting of the assessments includes, for each of the pharmaceuticals or groups of pharmaceuticals that are associated with a given indication, storing data that is representative of elements of value of the pharmaceutical or group of pharmaceuticals including elements within the domains of clinical efficacy, safety and use, and economics. The supporting of the assessment includes, by a computer, calculating a drug score for each of the pharmaceuticals and groups of pharmaceuticals based on the data that is representative of the elements of value, and

through a user interface, displaying the relative scores and the basis on which they were calculated to enable assessments of whether to include one or more of the pharmaceuticals or groups of pharmaceuticals in the one or more formularies.

These and other aspects, features, and implementations, and combinations will become apparent from the following description and claims, and can be expressed as methods, systems, components, software products, means and steps for performing functions, business methods, apparatus, and in other ways.

### DESCRIPTION

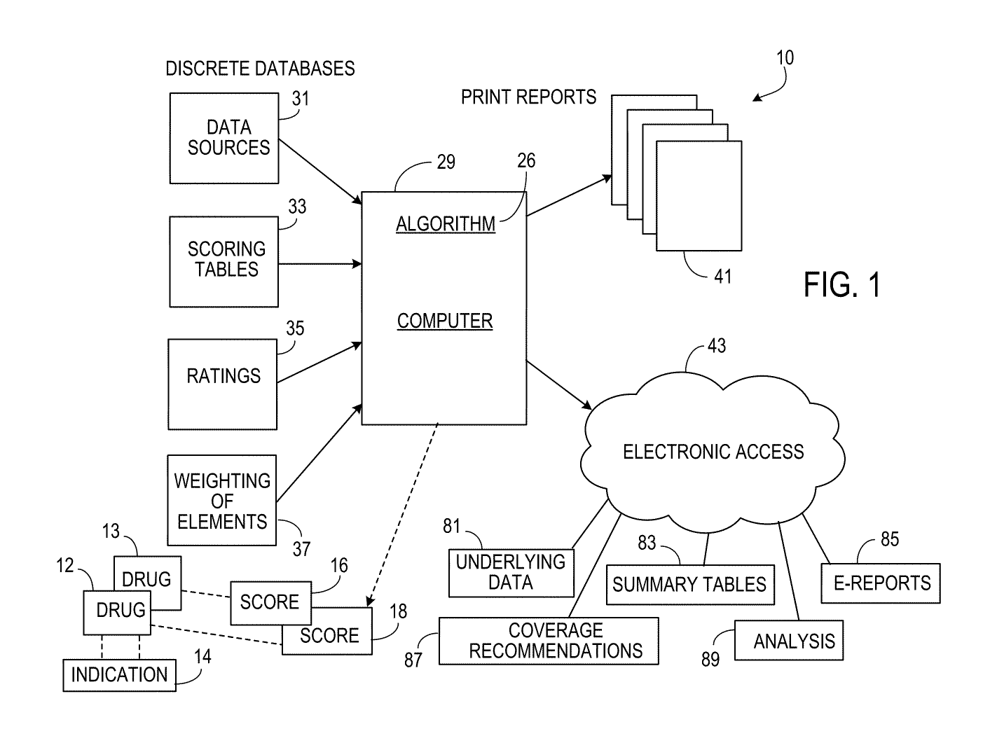

FIG. 1 is a flow diagram of inputs and outputs.

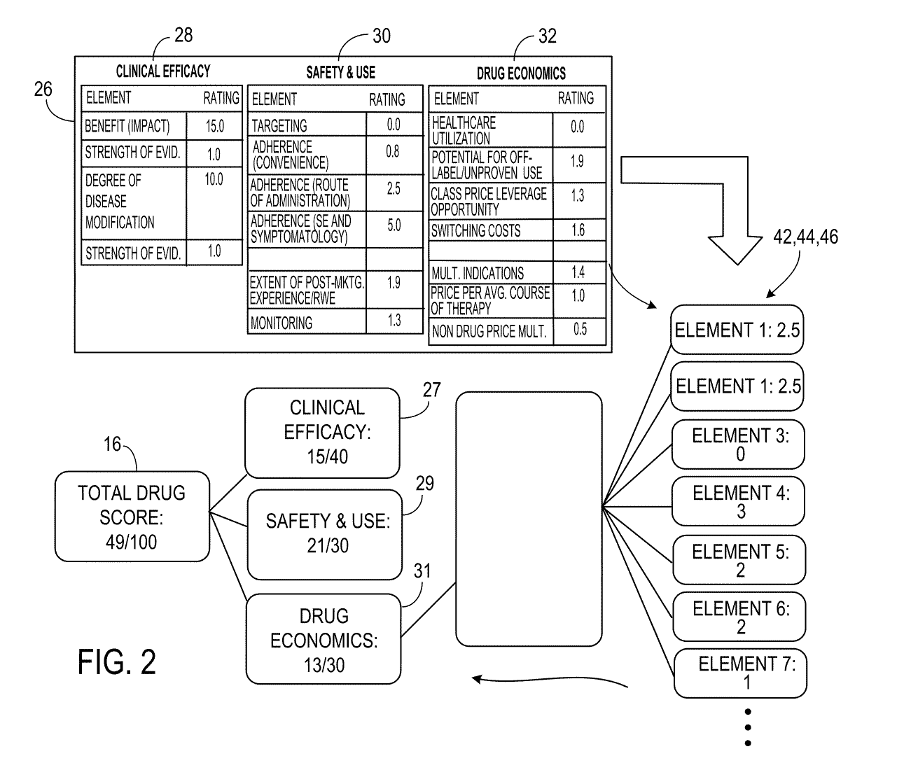

FIG. 2 is a block diagram.

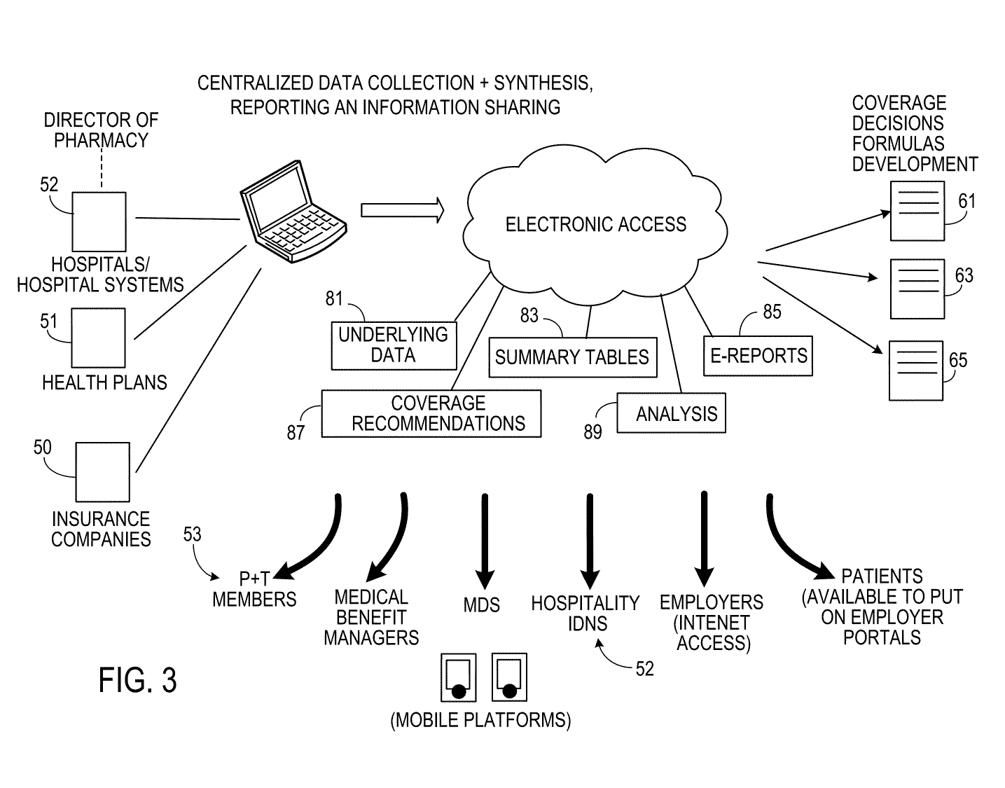

FIG. 3 is a flow diagram.

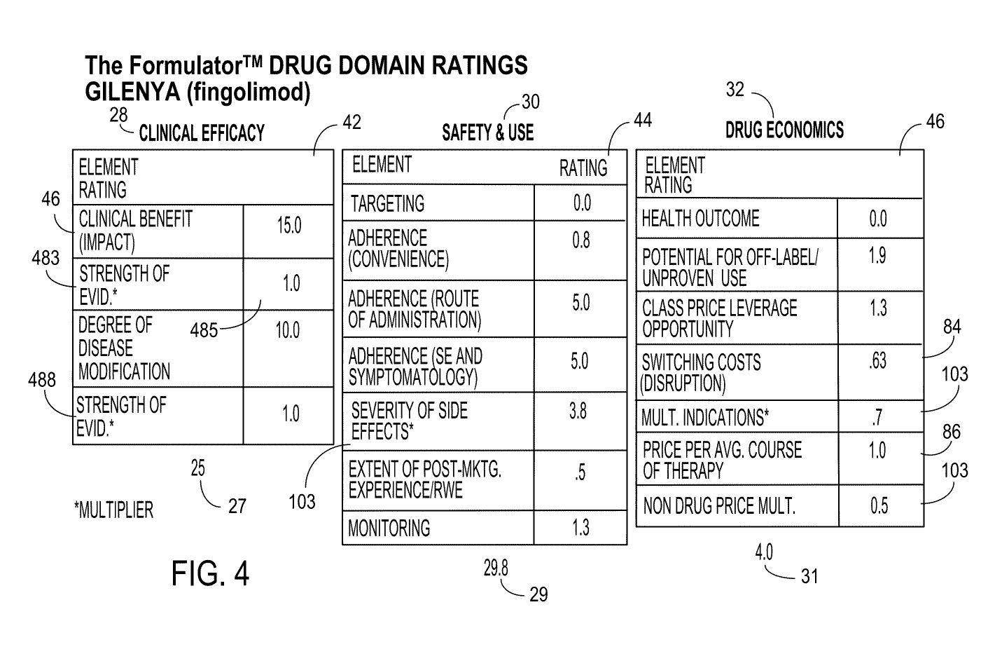

FIG. 4 is a table.

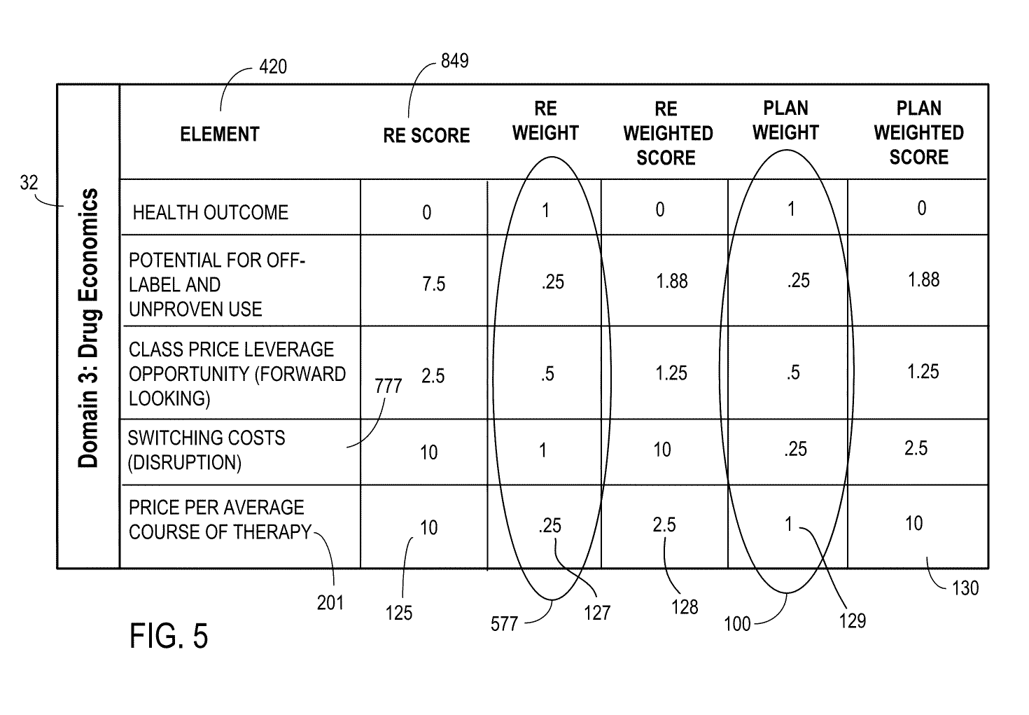

FIG. 5 is a table.

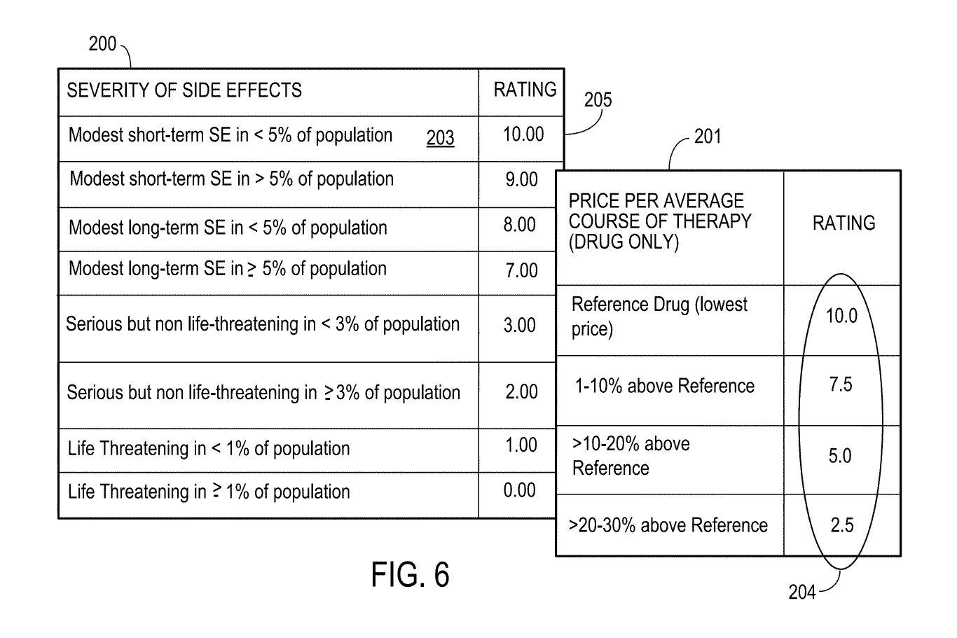

FIG. 6 is a table.

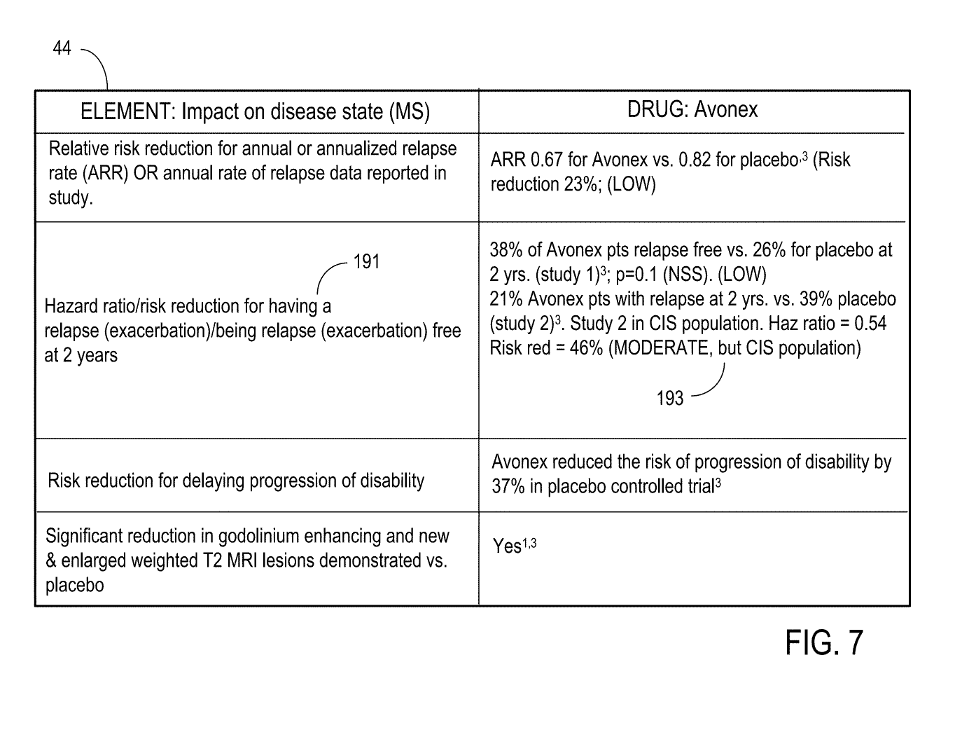

FIG. 7 is a table.

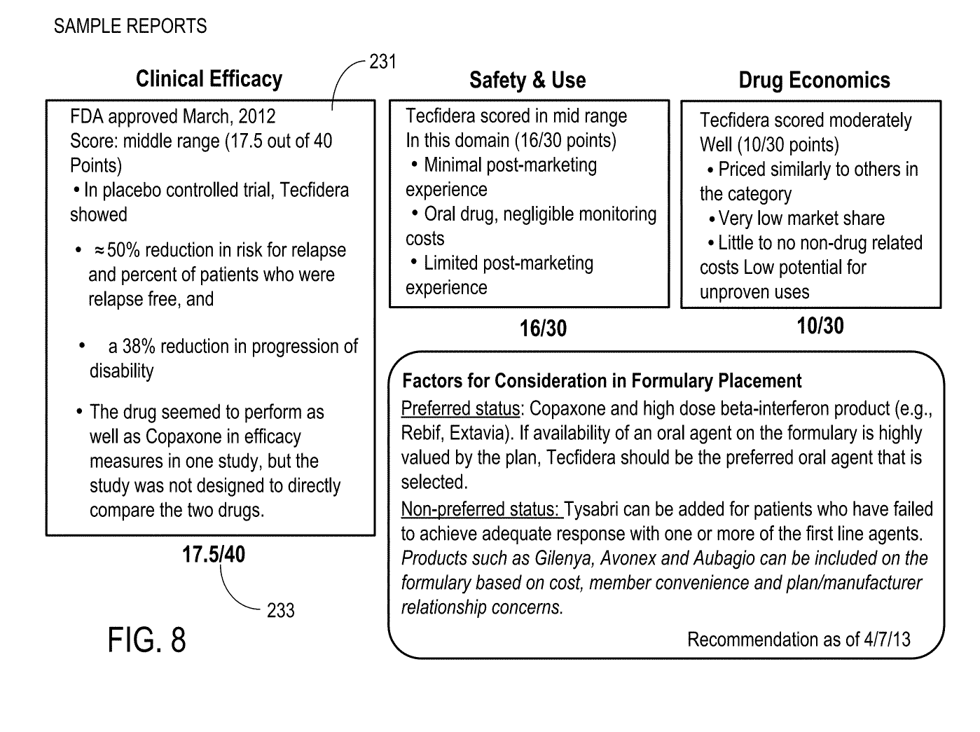

FIG. 8 is a block diagram.

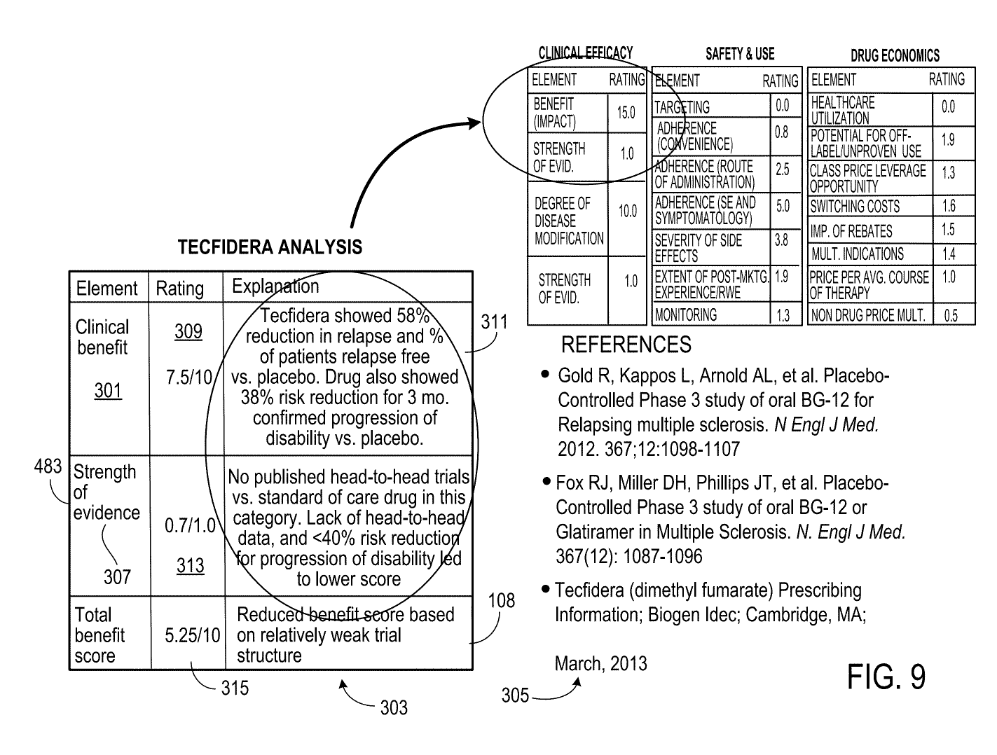

FIG. 9 is a table.

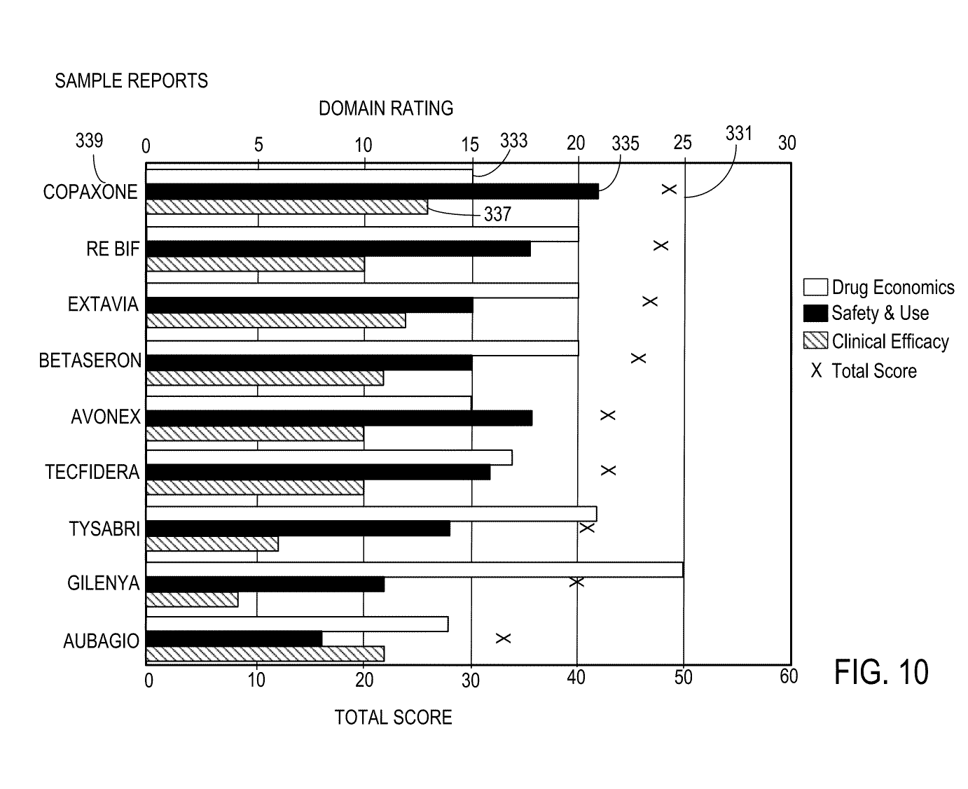

FIG. 10 is a chart.

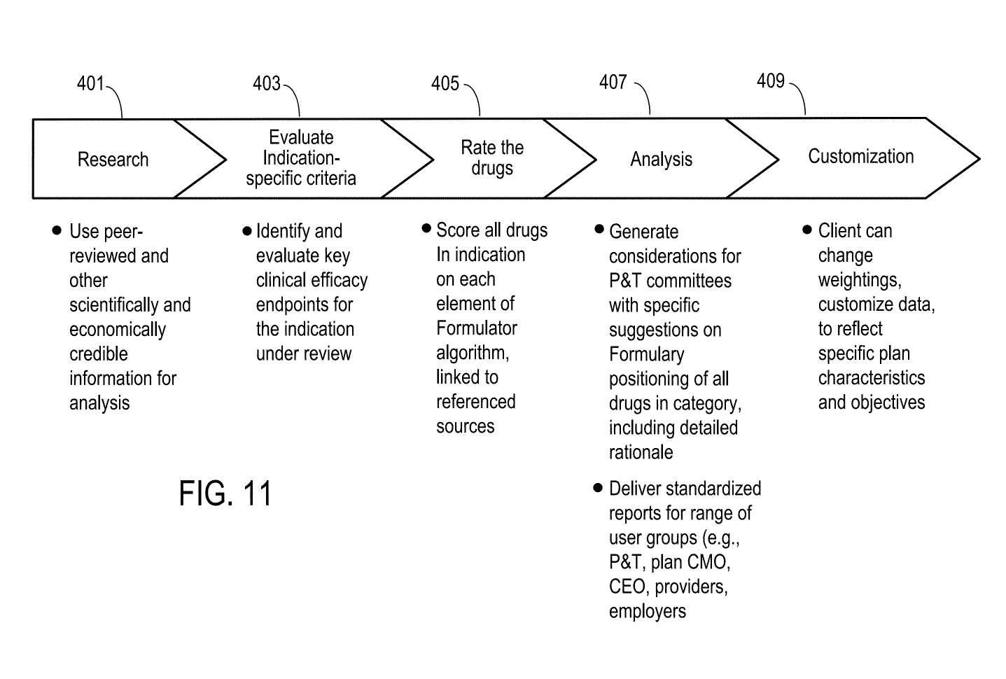

FIG. 11 is a time line.

FIG. 12 is a portion of a formulary.

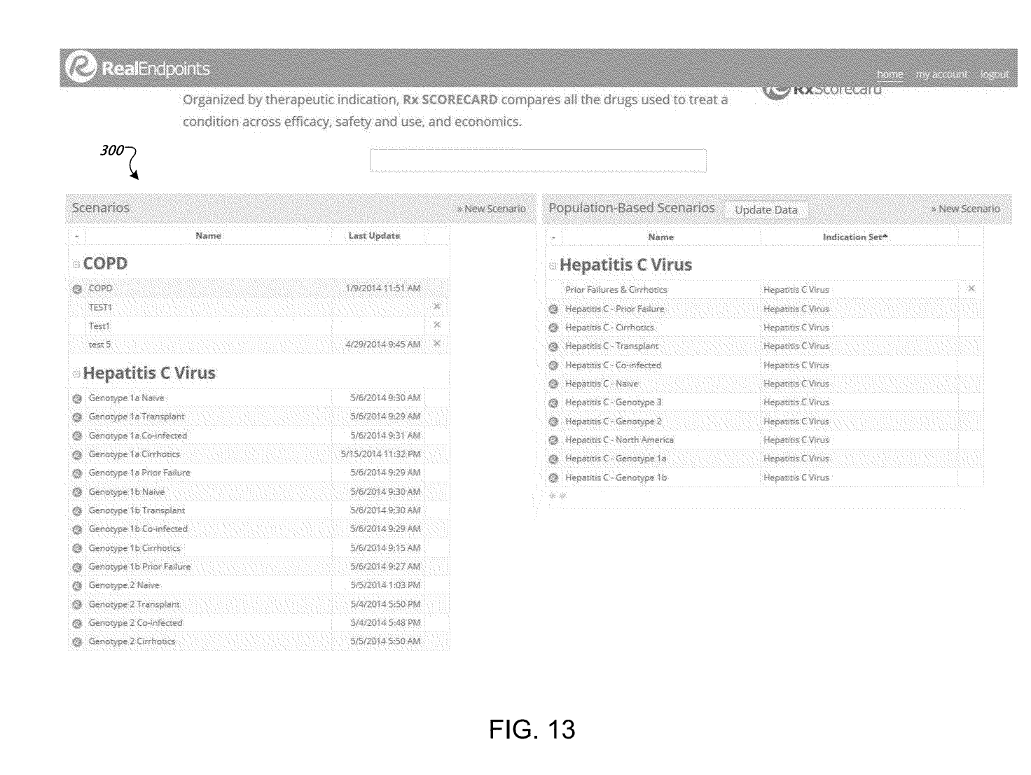

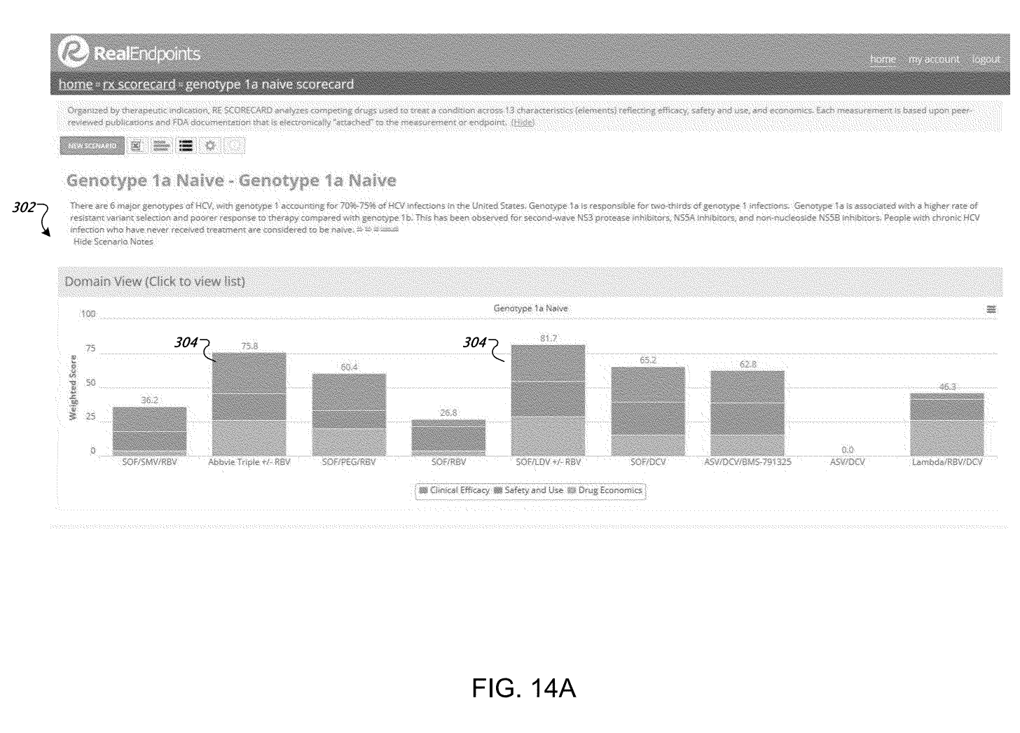

FIGS. 13-25 are screenshots.

As shown in FIG. 1, in the system 10, each drug 12 or multi-drug treatment regimen that can be used to treat a specific disease indication 14 gets a mathematical drug score 16 (that is, a quantitative indication) which can be used to compare the value of that drug to other drugs 13 used to treat the same indication 14. In some examples, a drug score is generated for individual drugs 12 for a specific disease indication. In some examples, a drug score is generated for a multi-drug treatment regimen (which we sometimes call a multi-drug regimen) that includes multiple drugs that are used in combination to treat a specific disease indication.

Each drug score 16, 18, is generated by an algorithm 26 running on a computer 29. The algorithm uses information from a variety of databases, including a database of externally available data sources 31, a database of element scoring tables 33, a database of ratings 35, and a database of weightings of elements 37, among others. The results of applying the algorithm can be provided from the computer 29 in the form of printed reports 41 or through online access 43 through the Internet or other communication medium. Those for whom access is authorized may have access to the underlying data 81 used by the algorithm, summary tables 83, e-reports 85, coverage recommendations 87, and analysis 89. The printed reports 41 and the electronic access 43 can include the scores generated by the algorithms for the various drugs associated with a given indication.

FIG. 2 is a diagram of the elements within each of three rating domains that are used by the algorithm in generating the total drug score 16. FIG. 3 is a representation of how the system is used by various customers (left) to communicate the assessment of drug value and the data and analysis underlying these assessments to stakeholders 53 in their jobs (bottom of FIG. 3) and the resulting reimbursement policies 61, 63, 65 that they must produce. The system can be used by other customers not shown in FIG. 3, such as drug companies, patients, investors, or other customers.

In some examples that we describe here, the algorithm evaluates drugs or multi-drug regimens on nineteen clinical efficacy 28, safety and use 30 and economic 32 elements in the three domains that are relevant to payers 50, 51, and providers 52 (and other stakeholders), creating an overall drug score 16 that is the sum of domain scores 27, 29, 31 for the three key domains 28, 30, 32—Efficacy, Safety and Use, and Drug Economics—each of which is itself the sum of specifically scored elements 42, 44, 46 (FIGS. 4, 5, and 7). In some examples, the algorithm evaluates drugs on more or fewer than nineteen elements. To evaluate a multi-drug regimen, the algorithm evaluates the drugs included in the multi-drug regimen collectively to arrive at a single drug score that is the sum of the scores for each of the three domains.

FIG. 4 shows examples of the rating elements 42, 44, 46 for all three domains 28, 30, 32 for the drug Gilenya (fingolimod). FIG. 5 shows a sample list of elements 420 for the Drug Economics domain 32, how one drug was rated on each element (element score) within the domain “Drug Economics”, and how a user may reassign her own weighting to each of these elements in order to obtain a drug score that reflects a particular health plan's beliefs about the relative importance of each element.

A number of these rating elements can be modified by multipliers to present a more meaningful (e.g., more realistic or more useful) element score. For example, a drug's clinical benefit element score 46 reflects its performance in clinical trials. The more effective the drug, the higher the clinical benefit score. The algorithm of the system can incorporate a multiplier that reflects the “strength of evidence” as it relates to clinical data 483. For example, if the trial was structured as a placebo-controlled study, which is a relatively less challenging trial structure, the system can apply a multiplier of 70% (0.7 on a scale of 0.0 to 1.0) to modify (in this case reduce) the clinical benefit element score. If the trial was structured as a head-to-head comparison with standard of care and statistically powered for superiority, which is a very rigorous trial structure, the system can apply a multiplier of 100% to modify the clinical benefit element score. That is, a drug scoring 10 on efficacy and tested against placebo would receive a final efficacy (10)× strength of evidence (70%) element score of 7. A drug scoring 10 on efficacy and tested with a head-to-head trial against standard of care powered for superiority would score a final efficacy (10)× strength of evidence (100%) element score of 10. Other multipliers can be used in the algorithm to reflect factors such as strength of evidence relative to degree of disease modification 488, a non drug price multiplier 103, and other factors.

Referring to FIG. 5, individual elements can be weighted to reflect the relative importance of various characteristics of a drug. Each score 849 for a given rating element 420 can be weighted by a weighting factor 577 reflecting the rating element's relative importance. The weighting factor 577 can increase or decrease the value of its associated rating element 420. Each element score 849 is multiplied by the corresponding weighting factor 577 to arrive at an RE weighted score 850. The weighted element scores are added together to arrive at a domain score 27, 29, 31 (in this case, the Drug Economics domain 32).

The Drug Economics domain score 31, plus the domain scores 27, 29 of the Safety and Use and Efficacy domains (themselves the sums of their own constituent elements that are multiplied times weightings), equals the total drug score 16, 18 of the drug under assessment. Each of the rating elements (sometimes called Res), and each of the domain scores that make up the total score is assigned based upon a pre-set rating table for each element that is designed based upon the features (rating elements) of the drugs and the medical indication being analyzed 200. Examples of rating tables 200 for two factors (rating elements) are shown in FIG. 6. In other words, FIG. 6 shows examples of preset tables 200, 201, each of which describes a range of prose rating descriptions 203 for a given rating element and then a numerical rating 205 associated with each of the prose descriptions.

In some examples, a user (e.g., a plan) can elect to enter an alternate weighting factor 100 (FIG. 5) for one or more rating elements of a domain to reflect a higher or lower relative importance of each element to an end user. The system can calculate the total score by adjusting the weighting factors 483 of other elements proportionately upward or downward to derive an indexed drug score where 100 is the maximum total score. For example, within the Drug Economics domain 32, a drug can score a 10 on both the elements of switching costs 777 and price per average course of therapy 125, 201. But because, in this example, price is more important to a particular plan in making a formulary decision than switching costs, the plan can weight price at a full 100% and the switching costs at 25%. Thus a score of 10 on price is worth 10 in its plan-weighted element score while a score of 10 on switching costs is worth 2.5 in its plan-weighted element score. Thus, each element score in tables 28, 30, and 32 reflects the product of both the base element score and the weighting factor for that element.

The system is entirely customizable (FIG. 5). Users can change the score of any element within the constraints of the rating tables 200, 201 (FIG. 6), the numerical value of each of the multipliers, the weightings of elements comprising domain scores, or a combination of any two or more of them. Because the algorithm automatically takes account of the weightings, this enables the user to alter the operation of the system so that it automatically changes the score of the drug under review to square with business policies, principles, preferences, or determinations made by a given stakeholder or user. Users can also customize their scores by using their own information (e.g., surveys of physicians) to arrive at the scores of each of the elements.

For example, as shown in FIG. 5 the system can base its Price per Average Course of Therapy 125, 201 on a traditional metric, Average Wholesale Price. However, a particular insurance company might have negotiated a significantly better price with a manufacturer. It can therefore easily enter its price (or actually, relative price band) in the system we describe here—which will improve the score of the drug. For example, the system assigns an RE base element score 125 based on Average Wholesale Price, which can be weighted by a weighting factor 127 to arrive at an RE weighted element score 128. A user representing a health plan can choose a higher element score from among the pre-set choices 204 in the pricing table 201 based on its negotiated lower price.

In some examples, real world evidence can be integrated into the drug evaluation approach. Users of the system can enter data from their own experiences into the system for drug evaluation. For example, clinical trial data for a particular drug may indicate that the drug is fairly well tolerated, and as a result the drug is assigned a moderate score for severity of side effects. A user has collected real world evidence in treating patients with the same drug and has found that some patients experience severe side effects. The user can change the score assigned for severity of side effects to reflect this experience, or the relative importance of the element as a component of the total score.

The system we describe here creates reports—targeted to different audiences—but all of which demonstrate the rationale for the scores. The table below lists examples of reports and their characteristics:

| Report Target | Report Objective | Communication Objective |
|---|---|---|
| CEO Report | One page, economics focused: | Supports senior level |
| | high level, key information | communications with Board of |
| | needed to support clinical | Directors and other key |
| | rankings and financial | financial/business |
| | opportunities for the plan. | stakeholders. |
| Medical Director | 1-2 page report highlighting | Focuses on Medical Director |
| Report | essential elements of clinical and | communication with important |
| | financial analysis of a drug class. | members of her/his staff as |
| | Key clinical studies/references | well as physician network, |
| | cited to support rankings and | thought leaders, and other key |
| | financial opportunities. | health benefit vendors. |
| | Drugs in development to watch | |
| | for | |
| | Highlights of formulary and UM | |
| | strategies outlined | |
| Benefit Manager | 1-2 page report highlighting | Assists the Benefit Manager |
| (employer client) | essential elements of the drug | when communicating with |
| Report | class. | employees about drugs that are |
| | Written in laymen's (non- | covered within the plan and |
| | clinical) terms | when responding to questions |
| | Overview of how medications | about utilization management |
| | compare across the class | programs. |
| | Highlights important aspects of | |
| | formulary and utilization | |
| | management programs | |
| Pharmacy Director | 6-10 page Full detailed drug class | Facilitates communication |
| Report | analysis | with prescriber network, |
| | Combination of text and tables at | internal staff, front line RPhs, |
| | drug and class level | PBM and other vendors, as |
| | Covers all elements of system | well as P&T Committee |
| | including references to key | meeting preparation. |
| | clinical studies and other | |
| | literature supporting ratings | |
| | Recommendations for utilization | |
| | management | |
| | Highlights of pipeline drugs in | |
| | development within the class | |
| Clinical Service | 1-2 pages | Assists with patient |
| Provider Report | Highlights of clinical benefits | discussions about medication |
| | and comparative efficacy across a | options that align with Health |
| | drug class with supporting | Plan benefit design. Helps |
| | reference citations. | clinical staff understand and |
| | Includes an outline and clinical | manage opportunities for better |
| | rationale for utilization | plan alignment. |
| | management. | |
| P&T Committee | Similar to the pharmacy director | Supports formulary and |
| Report | report | coverage decision processes |
| | Includes summary tables along | and discussions with other |
| | with in-depth clinical analysis | internal and external thought |
| | details and references across all | leaders. |
| | elements for each drug within | |
| | and across the class. | |

The table below lists some of the characteristics of existing approaches and corresponding characteristics of the system that we are describing.

| Existing approaches | The described system |
|---|---|
| Qualitative, unsystematic, | Algorithm-defined process: |
| subject to personal biases | objective, analytic & quantitative |
| Opaque | Transparent |
| Three basic criteria: safety, | Comprehensive view based on |
| efficacy, price | wide variety of drug, evidentiary, |
| | competitor, usage, economic |
| | elements |
| 13-15 P&T decisions/year (avg.) | Scoring on virtually all new drug |
| | approvals, within weeks of |
| | approval |
| Infrequent updates | Constant updates |
| Pharmacy-benefit drugs | Pharmacy and medical benefit |
| | drugs |
| One drug at a time | Drugs in context of entire class |
| No clear report summarizing | Clear report summarizing |
| decision and decision logic | decision and decision logic |
| Credibility questionable: Some | Completely credible: deep |
| formulary decision-makers (e.g., | expertise within team; business |
| PBMs) have economic | model independent of drug |
| incentives that could bias their | buying/selling |
| assessments of particular drugs | |
| Rarely reviews near-term | Reviews all key near-term |
| pipeline (unapproved) drugs | pipeline drugs, assessing relative |
| whose approval could make | value to currently marketed and |
| significant clinical and economic | other near-term pipeline drugs. |
| impact on plan. | |

Thus, the system we describe here creates formulary recommendations based on the scores generated for drugs using the algorithm, the input data, and the customizations of the users.

As shown in FIG. 7, the system accumulates, analyzes, organizes, and presents to users and stakeholders, information that supports and explains the basis on which ratings, and therefore sub-scores and scores are built. This enables the user or stakeholder to review, second guess, challenge, accept, and use with confidence the ratings information provided by the system. In the example shown in FIG. 7, the element illustrates several impacts of a drug (in this case Avonex) on a disease state of (in this case) multiple sclerosis (MS). In the left column are clinical endpoints 191. In the right column opposite each clinical endpoint is how one drug, Avonex, performs against each of these endpoints, based upon available data used to evaluate the drug. (see information inputs in FIG. 1).

FIG. 8 shows an example of a prose report summarizing the ratings for the drug Tecfidera. This report outlines the key analyses that drove the ratings of the drug in each of the three domains. Clinical efficacy was rated based upon the drug's performance in clinical trials and the way those studies were conducted. The safety and use rating of Tecfidera is tempered by the fact that the drug was recently approved by the FDA, but some facts about the marketed use of the drug are publicly available. Drug economics is rated based upon public information about the pricing of the drug relative to other drugs in the indication as well as other costs related to taking the drug. Underneath each domain explanation 231 is the score 233 for the drug in each domain. There is a section on this report 235, Factors for Consideration in Formulary Placement. This is provided to the user to help decide the level of reimbursement for this drug, which is represented by where it is placed on the formulary for a given health plan. FIG. 8 illustrates information that could be presented by printing a paper report, or made available electronically to users and stakeholders to understand the basis of the scoring. The information is available for every drug covered by the system and available anywhere and anytime. It provides information that is useful in assessing drugs.

FIG. 9 shows an example of the scoring of the rating element “Clinical Benefit” 301 for the drug Tecfidera, which includes the data 303 (linked to reference sources 305) used to determine the rating that was assigned for that element. Clinical Benefit is an example of an element that has a multiplier to modify the score, based on the strength of evidence 307. In this case the clinical benefit rating 309 is arrived at based upon the relapse rate and the progression of disability of the disease. This information 311 is linked to references 305 for the user's benefit. Underneath this element is the second component in the scoring of this element—Strength of Evidence 313. This element is scored based upon the structure of the clinical trials in which the data above were generated. By multiplying these two scores together the system generates a total clinical benefit score for the drug 315. On the upper right hand of the report is a representation of each element and in which domain each element is categorized. Each one of these elements is scored in the same manner as the one described in this paragraph.

FIG. 10 shows an example of one of the outputs from the system. This is a report which can be provided online to users and stakeholders and displays the rating 331 of the drugs 339 in each of the three domains in the Multiple Sclerosis indication. The purpose of this chart is to allow the user to compare the performance of the drugs in a given indication along three dimensions or domains: Clinical Benefit, Safety & Use, and Drug Economics 333, 335, 337, respectively. For example, a health plan may cover a population of patients that are elderly and therefore require drugs that are easier to use and have fewer side effects. In this case the user would be able to quickly see that the safety & use domain score for Copaxone is the highest in this group and also has the highest overall drug score; therefore they should conclude that this drug should be the preferred drug for their population. The length of each bar indicates the drug's domain score in each of the three domains 333, 335, 337. The numerical score for each bar is indicated on the axis at the top of the chart. The total drug score for each drug is indicated by an X and is related to the axis at the bottom of the chart.

FIG. 11 shows a diagram of the research and evaluation process we follow in order to generate the outputs depicted in FIG. 1. The first step in evaluating a class of drugs for an indication is to review 401 the publicly available literature and published clinical trials that have been reviewed by the FDA as part of the drug approval process. Once this information has been evaluated, the evaluators (analysts) determine 403 which criteria or clinical endpoints are most relevant to the indication this group of drugs is designed to treat and creates a scoring table for each element to assign a numerical value to each result. Next, each drug is scored 405 based upon these criteria and each drug is rated on every element in the algorithm and the scores are calculated and indexed to 100 automatically. Finally, the team of analysts reviews 407 the results of the drugs as they compare to one another and draws conclusions about the implications of these results for considering reimbursement and formulary placement. The system generates reports on the drugs and the indication overall from the inputs and analysis that has been performed. We sometimes refer to these reports as scorecards. Users may customize 409 the results of the scores in several ways. Users may draw different conclusions from the primary research than the analysts who rated the drug and can change interactively through a computer any individual score accordingly, and the weighting of each element may also be changed interactively through a computer by the user to reflect his/her perspective on the relative importance of each of the elements in the scoring process. The system will calculate an indexed score based upon the changed inputs. These revised scores will be reflected in the reports that the system generates if the user chooses.

In some examples, a single scorecard can be generated for the drugs or multi-drug regimens that are evaluated for the treatment of a particular indication. For instance, in an example, a single scorecard can be generated for a set of six drugs that were evaluated by the algorithm for the treatment of Hepatitis C.

In some examples, patients having a particular indication can be divided into sub-groups based on one or more disease characteristics, one or more patient characteristics, or both. We sometimes refer to a group of patients that is defined based on a disease subtype characterized by the genetic composition as a genotype. We sometimes refer to a group of patients that is grouped based on a patient characteristic as a sub-population. For instance, example sub-populations of Hepatitis C patients include patients who have not previously received any Hepatitis C treatment, patients who have received a liver transplant, patients who are suffering from liver cirrhosis, or other sub-populations; subtypes are genetic variants of the disease such as genotype 1a, genotype 1b or genotype 2.

In some cases, one sub-population or genotype of patients having a particular indication may react differently to a drug or treatment regimen than another sub-population or genotype of patients having that same indication. To capture these fine-grained differences in patient response to treatment, multiple scorecards can be generated for the drugs or multi-drug regimens that are evaluated for the treatment of a particular indication. Each scorecard can apply to one or more sub-populations, one or more genotypes, or a combination of any two or more of them. That is, for instance, in a scorecard for a particular genotype or sub-population, the element scores, domain scores, drug scores, or a combination of any two or more of them are calculated specifically for patients belonging to that sub-population.

Referring generally to FIGS. 13-25, scorecards for one or more drugs or multi-drug treatment regimens for each of one or more general indications, one or more genotypes or sub-populations, or both can be presented on a user interface. Through the user interface, a user can view the domain scores, element scores, weightings, and other factors that contribute to the ratings shown on the scorecards. In some examples, the user can also modify scores, weightings, or other factors, or a combination of any two or more of them.

Referring to FIG. 13, the user can access scorecards for various diseases through a menu 300 of the user interface. For one or more of the diseases, scorecards can be available for particular genotypes, particular populations (population-based scenarios constructed by “rolling up” scorecards for relevant sub-populations, or both. In the example of FIG. 13, scorecards are available for the diseases chronic obstructive pulmonary disease (COPD) and Hepatitis C variants such as genotype 1a and sub-populations such as cirrhotic or naïve.

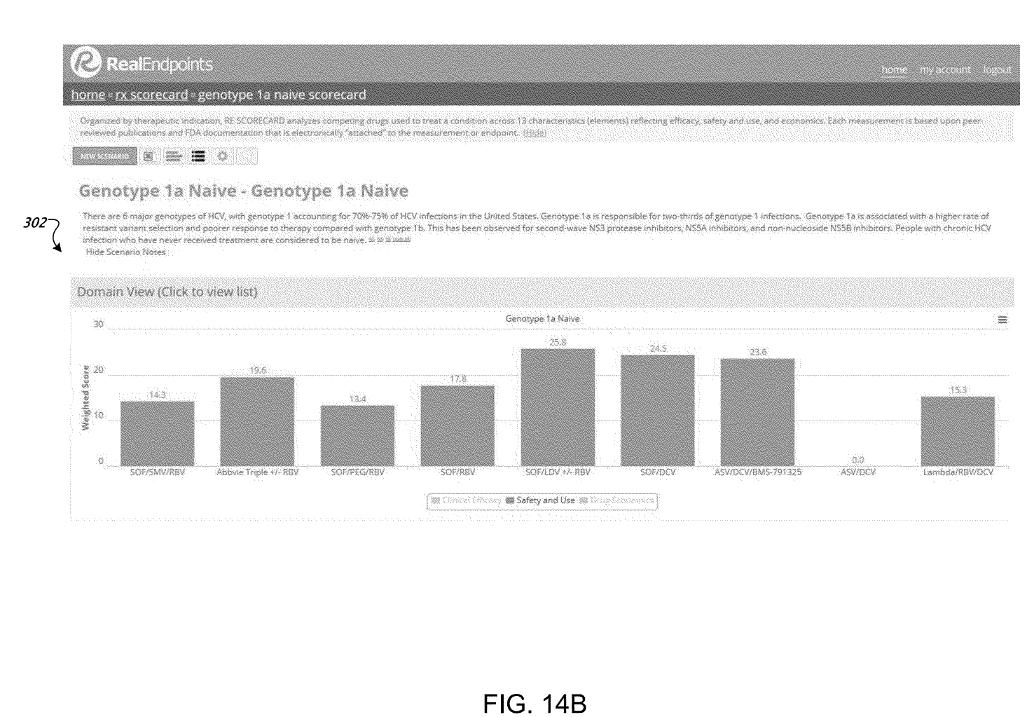

FIG. 14A shows an example graphical domain scorecard 302 including drug and domain scores for various drugs and multi-drug regimens for the treatment of Hepatitis C in patients categorized as Genotype 1a Naïve. Each bar 304 represents the sum of the three domain scores (clinical efficacy, safety and use, and drug economics) for the corresponding drug or multi-drug regimen and includes three sections representing the three domain scores. The graphical presentation of drug and domain scores provided by the graphical domain scorecard 302 enables a user to visualize differences among the performance or suitability of various drugs or multi-drug regimens. For instance, from the graphical domain scorecard 302 shown in FIG. 14A, it is readily apparent that the multi-drug regimens SOF/RBV and ASV/DCV do not perform well for Genotype 1a Naïve patients, and that other drugs or multi-drug regimens may be preferable for treating these patients.

In some examples, the graphical domain scorecard 302 can be interactive, e.g., allowing a user to select one or more of the domains, drugs, or multi-drug regimens for display or for removal from the display. The interactive nature of the graphical domain scorecard 302 allows the user to focus on one or more domains of interest, drugs or multi-drug regimens of interest, or both. For instance, in FIG. 14B, the domain scores for clinical efficacy and drug economics have been removed from the bar graph, allowing the user to view only the safety and use scores for each of the drugs and multi-drug regimens.

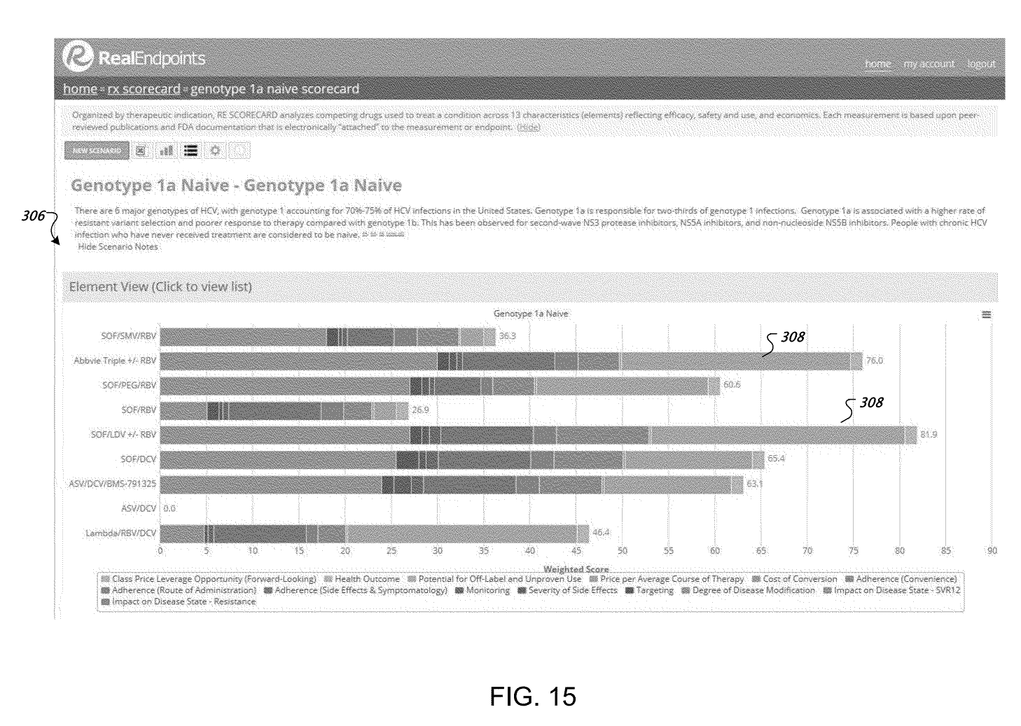

FIG. 15 shows an example graphical element scorecard 306 including drug and element scores for various drugs and multi-drug regimens for the treatment of Hepatitis C in patients categorized as Genotype 1a Naïve. Each bar 308 represents the sum of the element scores for the corresponding drug or multi-drug regimen and includes multiple sections, each representing an individual element score. In some examples, the graphical element scorecard 306 can be interactive, e.g., allowing a user to select one or more of the elements, drugs, or multi-drug regimens for display or for removal from the display. The interactive nature of the graphical element scorecard allows the user to focus on one or more elements of interest, drugs or multi-drug regimens of interest, or both. The graphical presentation of element scores provided by the graphical element scorecard 306 enables a user to visualize fine-grained differences, at the element level, among the performance or suitability of various drugs or multi-drug regimens.

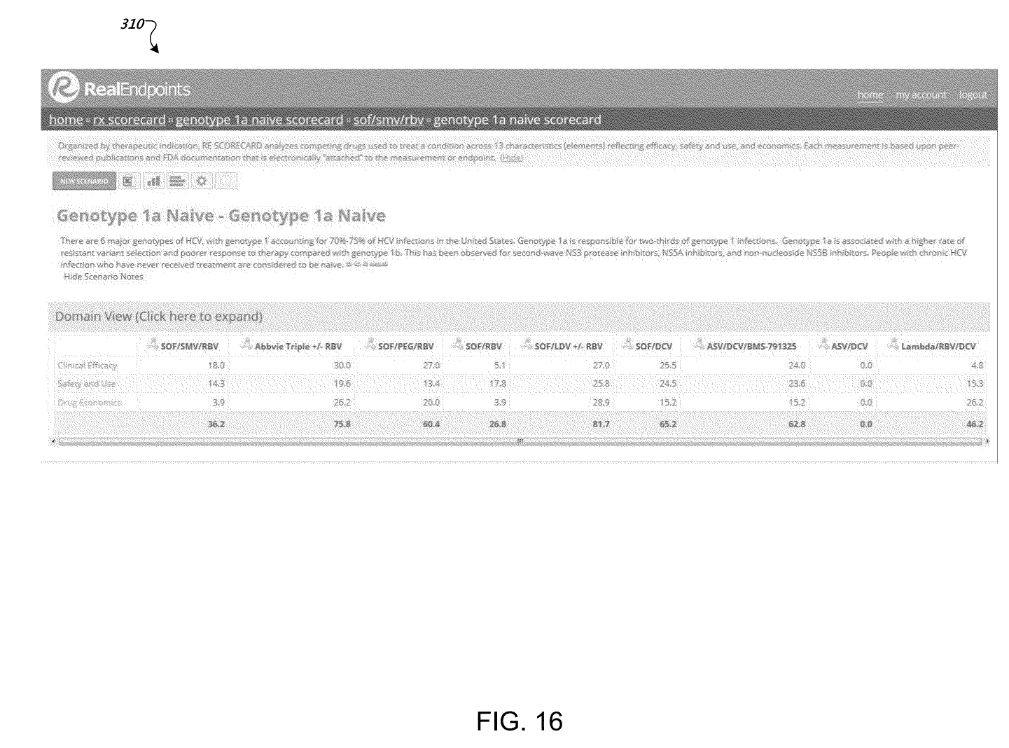

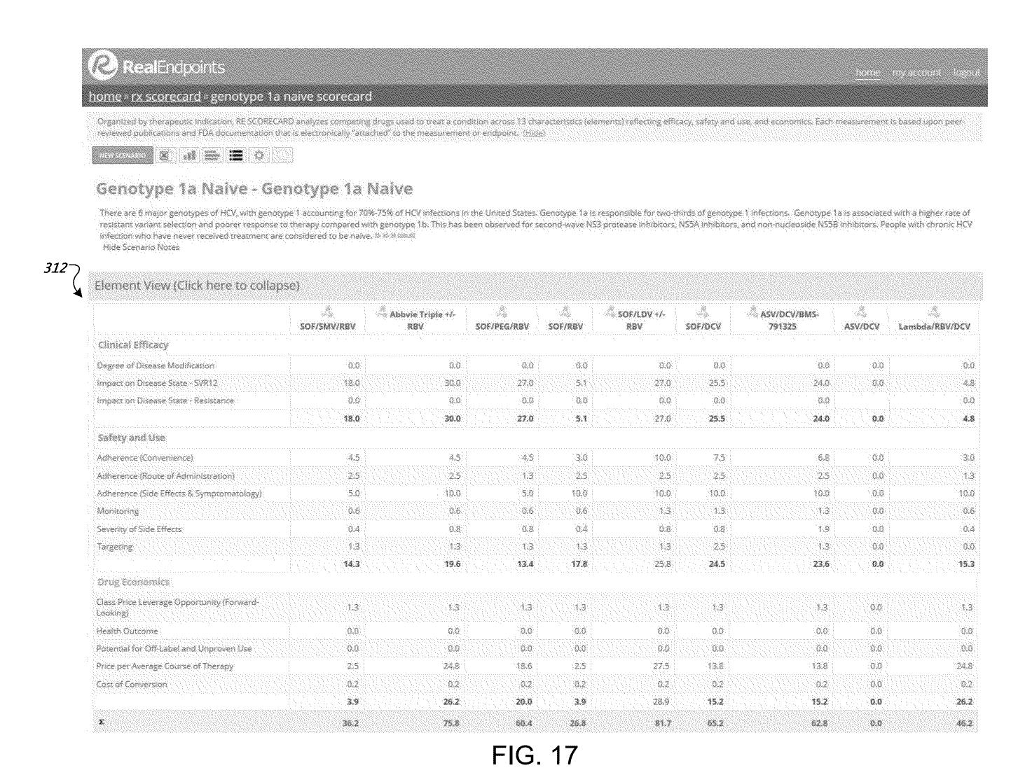

Referring to FIGS. 16 and 17, domain scores and element scores can be displayed in a tabular domain scorecard 310 and a tabular element scorecard 312, respectively, providing a user with easier access to the actual numerical score values.

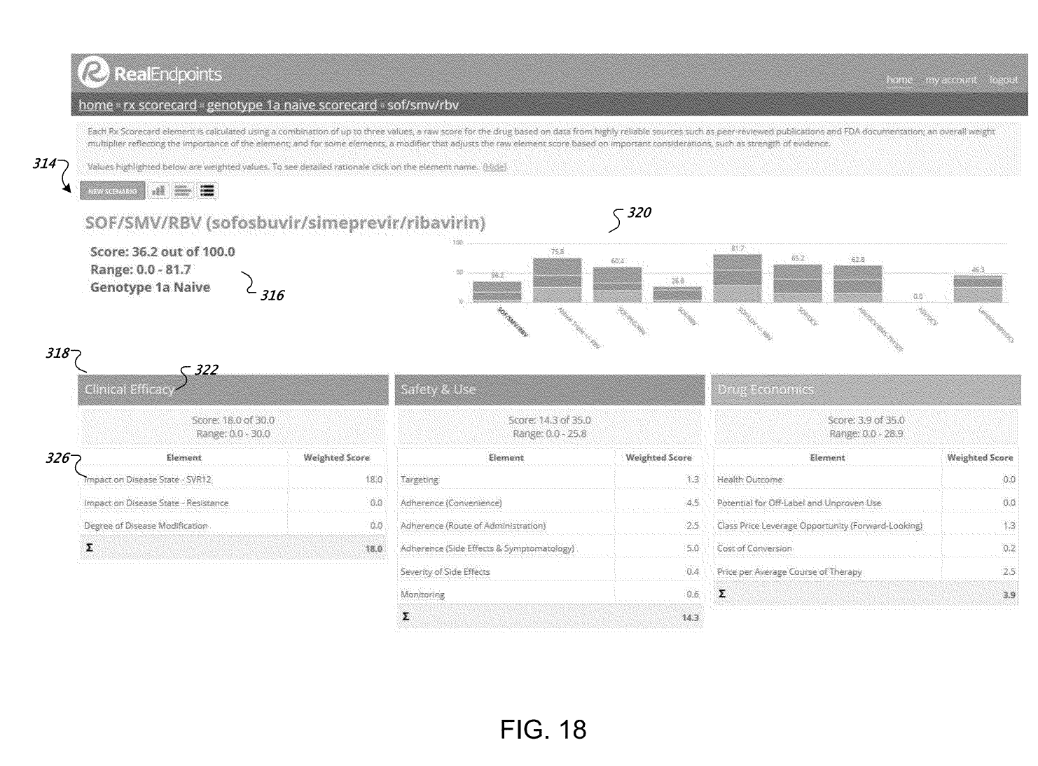

Referring to FIG. 18, detailed information for a particular drug or multi-drug regimen can be displayed in a drug scorecard 314. For instance, the example drug scorecard 314 shown in FIG. 18 shows domain and element scores for the multi-drug regimen SOF/SMV/RBV (sofosbuvir/simeprevir/ribavirin) for Genotype 1a Naïve patients. A score overview 316 describes the overall drug regimen's score and the range of total scores for all of the regimens used to treat HCV Genotype 1a Naïve patients. An element table 318 shows element and domain scores for each of the three domains. A graphical domain view 320 graphically depicts the domain and drug scores for SOF/SMV/RBV in comparison with other drugs and multi-drug regimens for Genotype 1a Naïve patients.

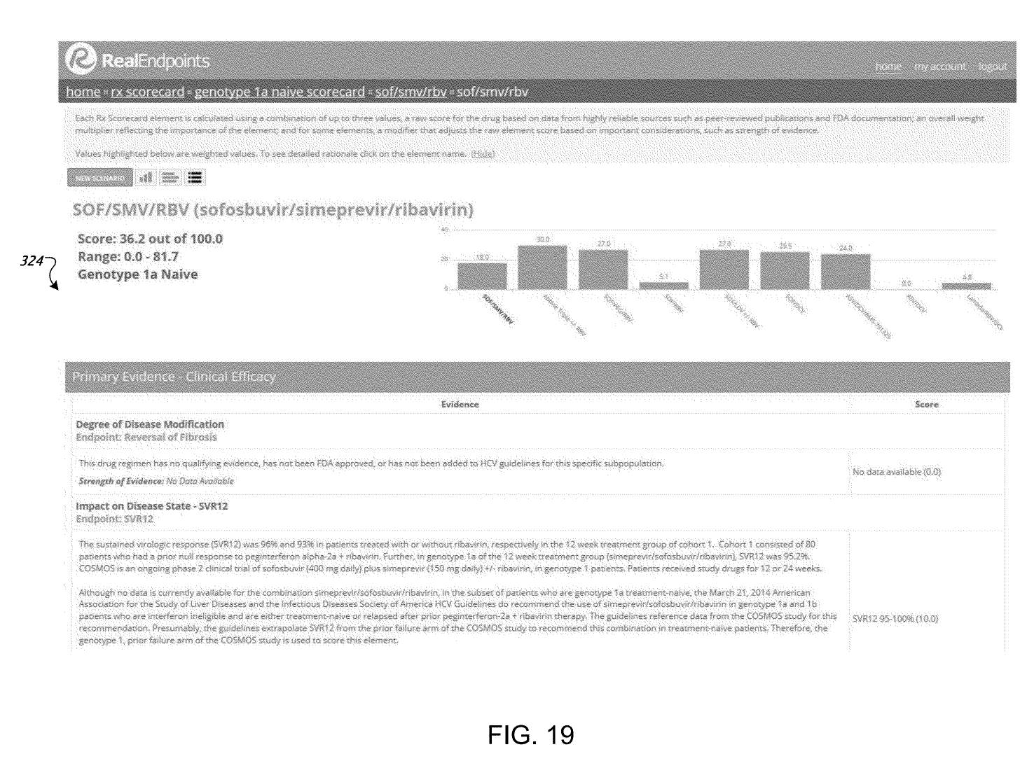

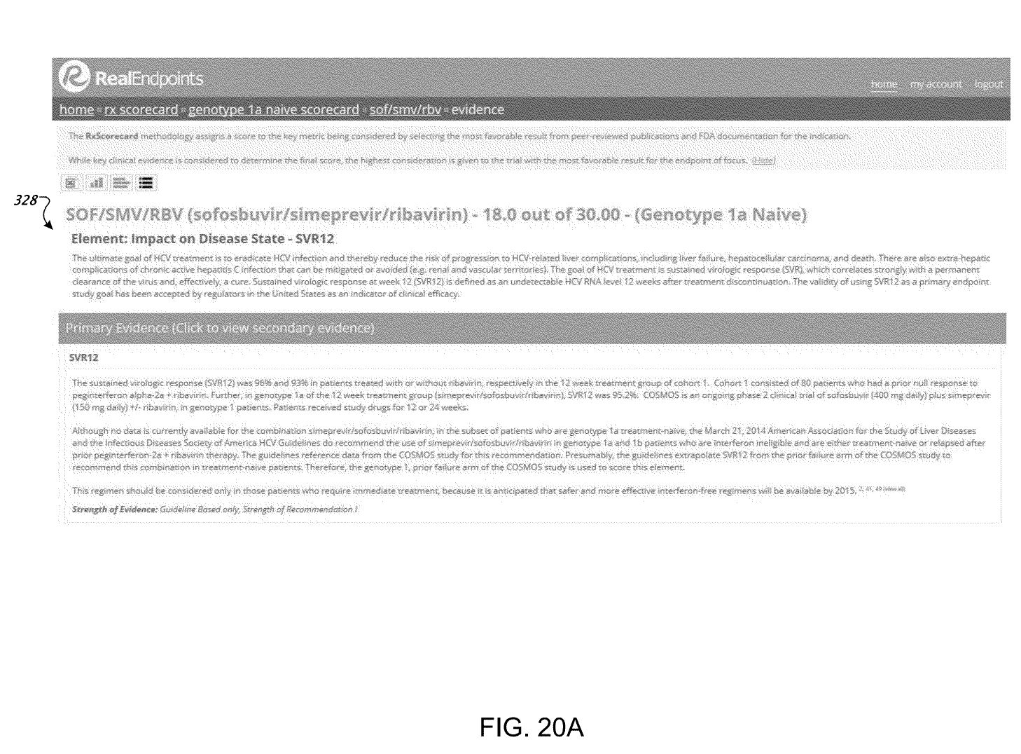

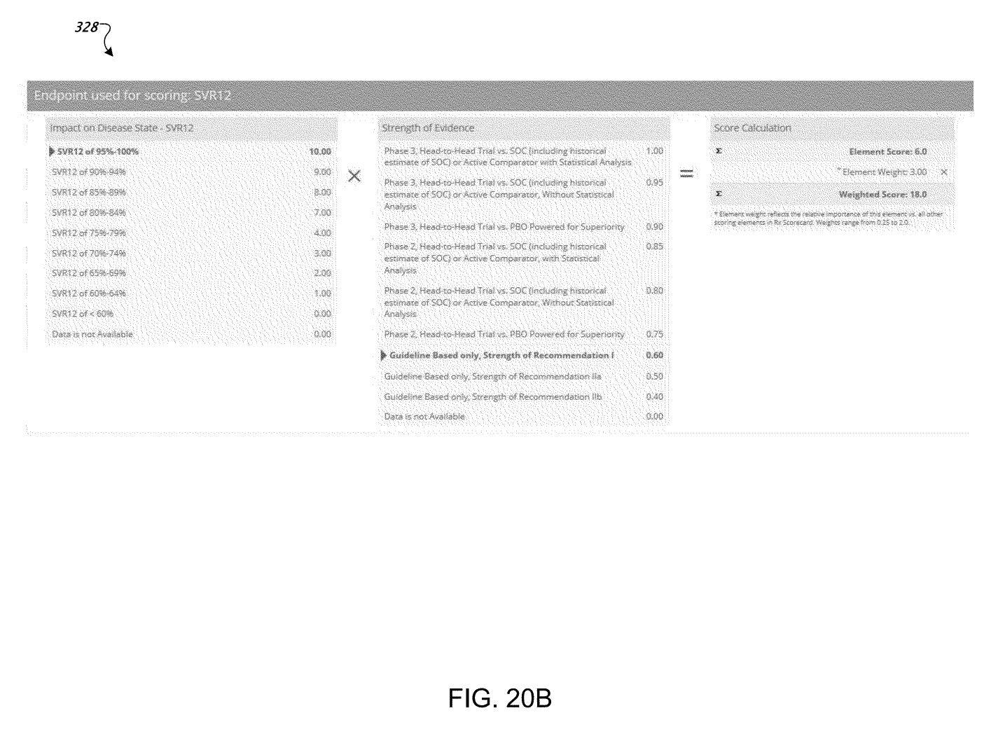

From the drug scorecard 314, the user can access additional information about the domain scores, element scores, or both. For instance, the user can select (e.g., by clicking or tapping on) a domain name to access a description of some or all of the evidence for that domain. Referring to FIGS. 18 and 19, in one example, the user can click on the “Clinical Efficacy” domain name 322 to access a domain details view 324 that includes a description of evidence for the clinical efficiency domain for SOF/SMV/RBV for Genotype 1a Naïve patients. The user can also select (e.g., by clicking or tapping on) an element name to access detailed information and scoring data for that element. Referring to FIGS. 18 and 20A-20B, in one example, the user can click on the “Impact on Disease State” element name 326 in the clinical efficiency domain to access an element details view 328 that includes a description of primary and secondary evidence and scoring calculations for that element.

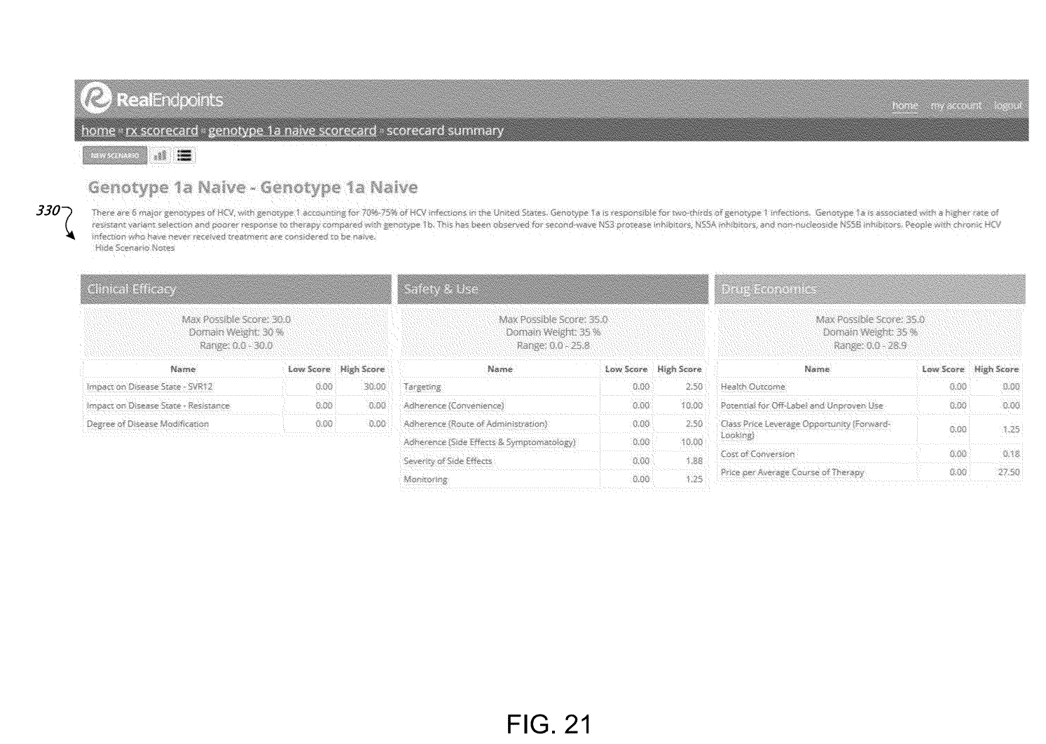

Referring to FIG. 21, an overview view 330 shows a summary of domain scores and element scores for the drugs and multi-drug treatment regimens for SOF/SMV/RBV for Genotype 1a Naïve patients. For instance, the overview view 330 shows the range of domain scores for each domain and the minimum and maximum score for each of the elements.

In some examples, the drug, domain, or element scoring data, or a combination of any two of them, can be exported to a file, e.g., a spreadsheet or text file, enabling the user to analyze or manipulate the data.

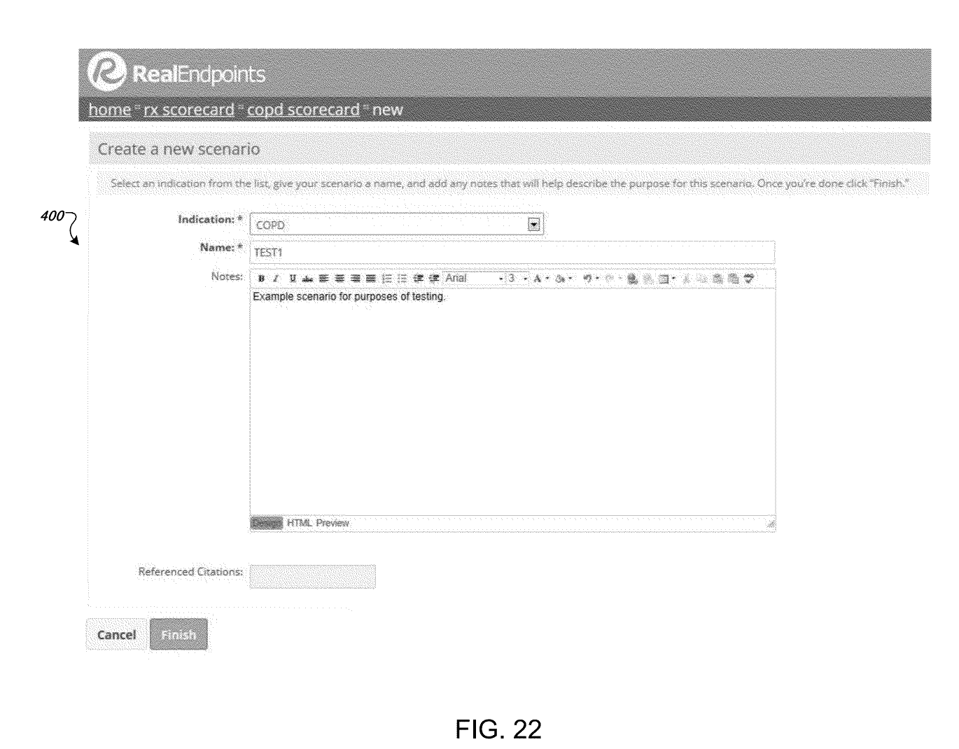

Referring to FIGS. 22-25, in some examples, the user interface allows a user to modify an existing scenario or create a new scenario. For instance, a user can create a new scenario that is based on an existing scenario, and change the score of any element, the numerical value of any of the multipliers, the weightings of the elements, or a combination of any two or more of them. The algorithm automatically calculates the score for the drugs or multi-drug regimens based on the user input. This flexibility enables the user to adjust the operation of the system such that the calculations of the algorithm align with medical or business policies, preferences, or determinations made by a given stakeholder or user. In some examples, a user can customize components of a scenario using his own knowledge or information. That is, for instance, the customization of the factors based on which drug scores are calculated enables the system to account for user perspectives on the relative importance of each of the elements, domains, or both.

Referring specifically to FIG. 22, in a creation dialog 400, a user can specify a general indication or particular genotype of a general indication based on which a new scenario is to be created. For instance, in the example shown, the user has indicated that the general COPD indication is to be used as the base scenario. By designating COPD as the base scenario, the weightings and multipliers of the general COPD scenario will be used as default values for the new scenario, subject to adjustment by the user.

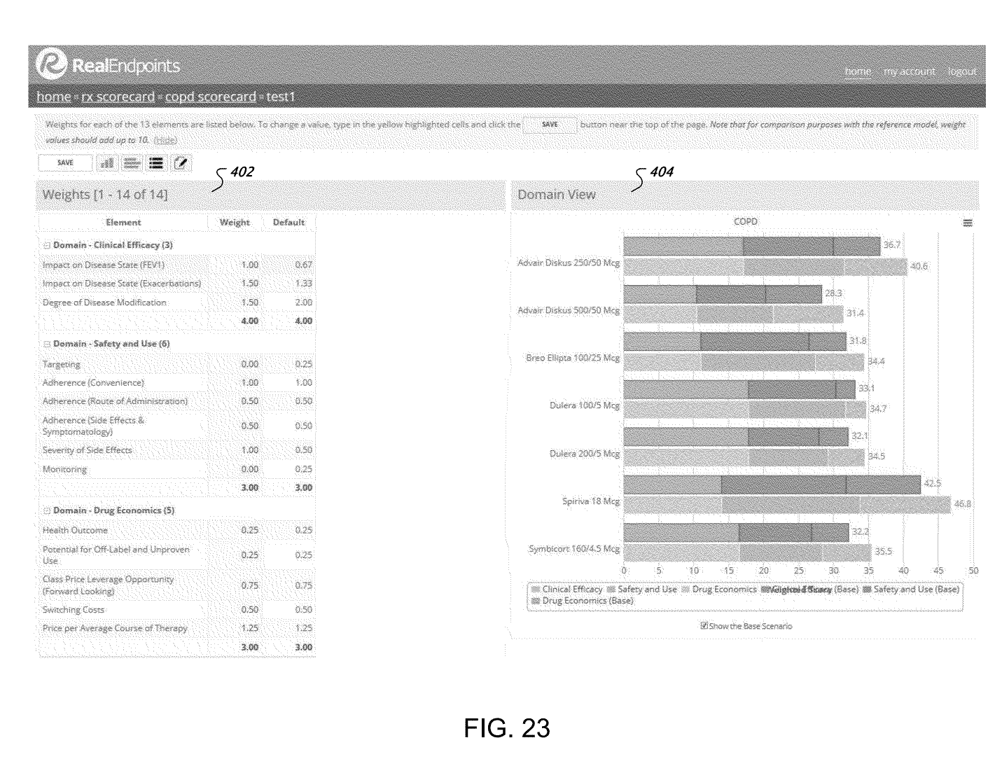

Referring to FIG. 23, in a weighting table 402, a user can specify the weighting for each element of the three domains in the new scenario. By default, the weighting for each domain is set to match the weighting in the base scenario. In the example shown, the user has adjusted the weightings for all three elements of the clinical efficiency domain and the targeting, severity of side effects, and monitoring elements of the safety and use domain. No changes have been made to the elements of the drug economics domain. A domain view 404 shows a graphical representation of the domain scores for each of one or more drugs or multi-drug regimens using the adjusted weightings. In the example domain view 404, the default domain scores are also depicted to enable the changes resulting from the adjusted weightings to be readily apparent.

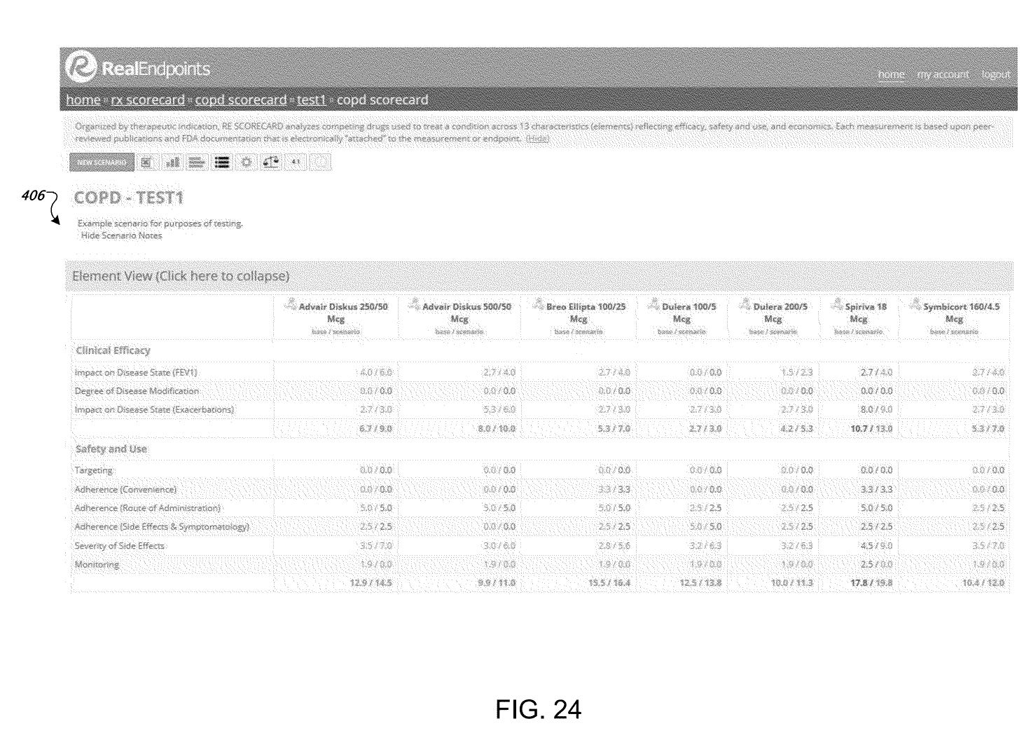

Referring to FIG. 24, a scenario element view 406 shows a score for each element calculated using the weighting specified in the weighting table 402 (FIG. 23). In the example element view 406, the default element scores are also shown for comparison.

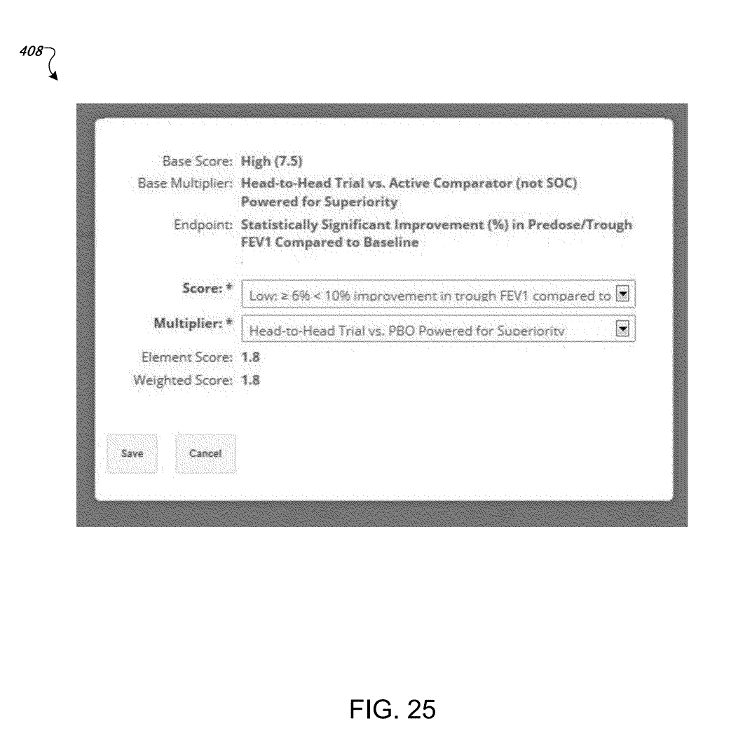

Referring to FIG. 25, a set of menus 408 enables the user to adjust scores, multipliers, or both for each element. For instance, the user can select a scoring band, multiplier band, or both, such as a low score or multiplier, a moderate score or multiplier, a high score or multiplier, or another scoring or multiplier band. The scoring band, multiplier band, or both are pre-populated and can be indicative of a score range or multiplier range desired by the user and can each correspond to a score or multiplier for the desired range. For instance, a particular score can be associated with each scoring band and a particular multiplier can be associated with each multiplier.

In some examples, one or more of the scores, such as the overall drug score, one or more domain scores, or one or more element scores can be used to guide selection of a drug therapy for a patient. For instance, the scores for each of various sub-populations can be used to identify which drugs or multi-drug treatment regimens may be optimal for the sub-population to which the patient belongs. This evaluation can enhance efficiency of drug therapy selection, e.g., cost efficiency. For instance, when treating patients having a disease for which an expensive therapy option and a less expensive therapy option exist (e.g., Hepatitis C), this evaluation can identify one or more sub-populations for whom the less expensive therapy option may be a successful therapy and one or more sub-populations for whom the expensive therapy may be the more successful therapy. In this way, the expensive therapy option can be initially assigned only to some patients, thus resulting in cost savings for the payer. The tool also allows the user to model the cost of each set of treatments they wish to evaluate.

In some cases, the scorecards described here can be used to calculate the cost to an insurer of pharmaceuticals related to a particular disease under different scenarios and depending on different formulary coverage policy options. For instance, cost information can be calculated for each of one or more pharmaceuticals or groups of pharmaceuticals for each of multiple formulary choices, each of multiple coverage policy options, or both. The cost information can be provided to users, e.g., to enable the users to make informed decisions about cost effective treatment options for particular diseases under particular scenarios.

The system can be implemented in part or completely on a computing device or a mobile device. The computing device can be in any form of digital computers, such as laptops, desktops, workstations, personal digital assistants, servers, blade servers, mainframes, and other appropriate computers. A mobile device could be any form of mobile device, such as personal digital assistants, cellular telephones, smartphones, tablets, and other similar computing devices.

Such a computing device can include a processor, memory, a storage device, a high-speed interface connecting to memory and high-speed expansion ports, and a low speed interface connecting to low speed bus and storage device. Each of the components are interconnected using various busses, and may be mounted on a common motherboard or in other manners as appropriate. The processor can process instructions for execution within the computing device, including instructions stored in the memory or on the storage device to display graphical information for a GUI on an external input/output device, such as display coupled to high speed interface. In some implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The computing device may be implemented in a number of different forms such as a standard server, or multiple times in a group of such servers. It may also be implemented as part of a rack server system. In addition, it may be implemented in a personal computer such as a laptop computer. Alternatively, components from the computing device may be combined with other components in a mobile device.

A mobile device may communicate wirelessly under various modes or protocols, such as GSM voice calls, SMS, EMS, or MMS messaging, CDMA, TDMA, PDC, WCDMA, CDMA2000, or GPRS, among others. Short-range communication may occur, such as using a Bluetooth, WiFi, or other such transceiver (not shown).

The computers and mobile devices can run computer programs (also known as programs, software, software applications or code) that include machine instructions for a programmable processor, and can be implemented in a high-level procedural and/or object-oriented programming language, and/or in assembly/machine language.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are also within the scope of the following claims.

1. A method comprising
for each of several pharmaceuticals or groups of pharmaceuticals that are associated with a given indication, storing data that is representative of elements of value of the pharmaceutical or group of pharmaceuticals including elements within the domains of clinical efficacy, safety and use, and economics,
by computer, calculating a drug score for each of the pharmaceuticals and groups of pharmaceuticals based on the data that is representative of the elements of value, and
through a user interface, displaying the relative scores and the basis on which they were calculated to enable decisions about the pharmaceuticals or groups of pharmaceuticals.

2. The method of claim 1 in which the drug score comprises an aggregate of element scores associated with each of the domains.

3. The method of claim 1 in which the drug scores are for pharmaceuticals that are associated with a given medical indication.

4. The method of claim 1 in which the user interface displays at least one of the data, a summary table, a coverage recommendation, an analysis, an element score associated with one of the domains, and a drug score.

5. The method of claim 1 in which the calculating of the drug score comprises multiplying an element score associated with one of the domains by a weighting factor.

6. The method of claim 5 in which a multiplier is associated with at least one of the following criteria: (a) a strength of evidence, (b) an extent of post-marketing experience, real world evidence, or both, (c) one or more labeled indications, and (d) non-drug costs.

7. The method of claim 1 in which the user comprises at least one of a health care provider, a health care payer, a pharmaceutical company, a patient, or an investor.

8. The method of claim 1 comprising
enabling a user, through the user interface, to specify an arbitrary weighting factor to be applied to any one or more of the element values when the drug score is calculated.

9. The method of claim 1 comprising
pre-storing prose descriptions of a series of levels of value of at least one of the rating elements and a numerical rating associated with each of the levels, and
through the interface, enabling a user to select one of the levels and the numerical rating applied in calculating the drug score.

10. The method of claim 1 comprising storing and displaying, through the user interface, prose descriptions of states of a medical condition and, for each of the prose descriptions, a prose explanation of an impact of a pharmaceutical on the state of the medical condition.

11. The method of claim 1 comprising
displaying, through the user interface, a prose explanation of the basis, for each of the domains, of the drug score that is calculated, and factors for consideration in placing the pharmaceutical in a formulary.

12. The method of claim 1 comprising
displaying, through the user interface, an explanation of the basis for a rating and adjustment of a rating for a rating element, the explanation summarizing scholarly references.

13. The method of claim 1 comprising
displaying, through the user interface, a graph of the respective drug scores of each of two or more pharmaceuticals associated with a medical indication, in each of two or more domains of value.

14. The method of claim 1 comprising
enabling a user to place the pharmaceutical on a formulary, adjust a position of the pharmaceutical on the formulary, or both, based on the drug score.

15. The method of claim 1 in which a group of pharmaceuticals comprises a multi-drug treatment regimen.

16. The method of claim 1 in which the decisions comprise decisions based on a cost of the pharmaceuticals or groups of pharmaceuticals.

17. The method of claim 1 comprising displaying, through the user interface, cost information associated with one or more of the pharmaceuticals or groups of pharmaceuticals.

18. The method of claim 1 comprising calculating cost information associated with one or more of the pharmaceuticals or groups of pharmaceuticals for each of multiple formulary choices, each of multiple coverage policy options, or both.

19. The method of claim 18, comprising displaying at least some of the calculated cost information.

20. A method comprising
for each of multiple pharmaceuticals or groups of pharmaceuticals that are associated with a given indication, storing data for multiple patient sub-groups, the data for each patient sub-group representative of elements of value of the pharmaceutical or group of pharmaceuticals for the patient sub-group, the elements of value including elements within the domains of clinical efficacy, safety and use, and economics,
by a computer, calculating a drug score for each of the pharmaceuticals and groups of pharmaceuticals for each of the patient sub-groups based on the data for the patient sub-group representative of the elements of value, and
through a user interface, enabling a user to access a scorecard for each of the patient sub-groups, the scorecard for a patient sub-group displaying the drug scores for each of the pharmaceuticals and groups of pharmaceuticals for the patient sub-group.

21. The method of claim 20 in which the patient sub-groups comprise sub-populations of patients grouped by one or more patient characteristics, genotypes of patients grouped by one or more characteristics of the given indication, or both.

22. The method of claim 20 comprising enabling the user to modify one or more factors used by the computer in calculating the drug score.

23. The method of claim 22 comprising enabling the user to specify a weighting factor to be applied to one or more of the elements of value when the drug score is calculated.

24. The method of claim 20 in which the scorecard includes a graphical display of the drug scores, a tabular display of the drug scores, or both.

25. The method of claim 20 in which the scorecard is interactive.

26. The method of claim 20 comprising enabling identification of a target pharmaceutical or group of pharmaceuticals for each of the patient sub-groups based at least in part on the drug scores for each of the pharmaceuticals and groups of pharmaceuticals.

27. The method of claim 26 comprising enabling identification of the target pharmaceutical or group of pharmaceuticals based at least in part on a cost associated with each of the pharmaceuticals and groups of pharmaceuticals.

28. A method comprising
through a computer interface, enabling a user to review, for each of several pharmaceuticals or groups of pharmaceuticals that are associated with a given indication, data that is representative of elements of value of the pharmaceutical or group of pharmaceuticals including elements within the domains of clinical efficacy, safety and use, and economics, and a computer calculated drug score for each of the pharmaceuticals and groups of pharmaceuticals that is based on the data that is representative of the elements of value,
enabling a user to place the pharmaceuticals or groups of pharmaceuticals in positions on a formulary, and
creating coverage rules, policies, or both, for the pharmaceuticals or groups of pharmaceuticals based on the formulary.

29. A method comprising
supporting assessments of the values of respective pharmaceuticals or groups of pharmaceuticals with respect to particular criteria for inclusion in one or more formularies, the supporting of the assessments including
for each of the pharmaceuticals or groups of pharmaceuticals that are associated with a given indication, storing data that is representative of elements of value of the pharmaceutical or group of pharmaceuticals including elements within the domains of clinical efficacy, safety and use, and economics,
by a computer, calculating a drug score for each of the pharmaceuticals and groups of pharmaceuticals based on the data that is representative of the elements of value, and
through a user interface, displaying the relative scores and the basis on which they were calculated to enable assessments of whether to include one or more of the pharmaceuticals or groups of pharmaceuticals in the one or more formularies.
